(19) United States
(12) Patent Application Publication
(10) Pub. No.: US 2022/0362987 A1
(43) Pub. Date: Nov. 17, 2022

(54) SHAPING APPARATUS, SHAPING METHOD, COMBINATION PRODUCT, COMBINATION PRODUCT MANUFACTURING METHOD, WIG BASE, WIG, AND WIG MANUFACTURING METHOD

(71) Applicant: Toshishige FUJII, Kanagawa (JP)

(72) Inventor: Toshishige FUJII, Kanagawa (JP)

(73) Assignee: Ricoh Company, Ltd., Tokyo (JP)

(21) Appl. No.: 17/812,531

(22) Filed: Jul. 14, 2022

Related U.S. Application Data
(63) Continuation of application No. PCT/JP2020/047154, filed on Dec. 17, 2020.

(30) Foreign Application Priority Data
Jan. 22, 2020 (JP) 2020-008112
Mar. 31, 2020 (JP) 2020-063092

(51) Int. Cl. B29C 64/118; B33Y 30/00; B33Y 80/00; B33Y 10/00; B29C 64/209; A41G 3/00

(52) U.S. Cl. CPC B29C 64/118; B33Y 30/00; B33Y 80/00; B33Y 10/00; B29C 64/209; A41G 3/0075; A41G 3/0041; B33Y 70/00

(57) ABSTRACT

A shaping apparatus configured to use a shaping material to form a shaped product on a target placed on a shaping stage. The shaping apparatus includes a discharger configured to discharge the shaping material onto the target; and a processor configured to control a distance between the target and the discharger based on a characteristic value of the target.

### CROSS-REFERENCE TO RELATED APPLICATION

The present application is a continuation filed under 35 U.S.C. 111 (a) claiming the benefit under 35 U.S.C. 120 and 365 (c) of PCT International Application No. PCT/JP2020/047154 filed on Dec. 17, 2020, and designating the U.S., which is based on and claims priority to Japanese Patent Application No. 2020-008112, filed on Jan. 22, 2020, and Japanese Patent Application No. 2020-063092, filed on Mar. 31, 2020. The entire contents of the PCT International Application No. PCT/JP2020/047154, the Japanese Patent Application No. 2020-008112, and the Japanese Patent Application No. 2020-063092 are incorporated herein by reference.

### BACKGROUND OF THE INVENTION

### 1. Field of the Invention

The present invention relates to a shaping apparatus, a shaping method, a combination product, a combination product manufacturing method, a wig base, a wig, and a wig manufacturing method.

### 2. Description of the Related Art

Various proposals have been made for apparatuses that form three-dimensional structures. For example, a three-dimensional shaping apparatus using a thermoplastic resin as a shaping material has been proposed (see, for example, Patent Document 1).

In addition, there is a growing need for use of a three-dimensional shaping apparatus to form a three-dimensional structure on a target such as a fabric.

### SUMMARY OF THE INVENTION

### Technical Problem

However, there has been a problem that the three-dimensional shaping apparatus disclosed in Patent Document 1 has a low adhesion between a shaping material and a target on which the shaping material is placed, and the shaping material is likely to come off easily.

The present disclosure has been made in view of the above-described problem and is intended to obtain a shaped product with a high degree of adhesiveness between a shaping material and a target on which the shaping material is placed.

### Solution to Problem

According to one aspect of the present disclosure, there is provided a shaping apparatus configured to use a shaping material to form a shaped product on a target placed on a shaping stage. The shaping apparatus includes a discharger configured to discharge the shaping material onto the target; and a processor configured to control a distance between the target and the discharger based on a characteristic value of the target.

### BRIEF DESCRIPTION OF THE DRAWINGS

Other objects, features and advantages of the present invention will become more apparent from the following detailed description when read in conjunction with the accompanying drawings:

FIG. 1 is an overall view of a three-dimensional shaping apparatus according to a present embodiment.

FIG. 2 is a partial cross-sectional view illustrating an internal structure of an extrusion device of the three-dimensional shaping apparatus according to the present embodiment.

FIG. 3 is a block diagram illustrating a hardware configuration of the three-dimensional shaping apparatus according to the present embodiment.

FIG. 4 is a diagram illustrating a state in which the three-dimensional shaping apparatus according to the present embodiment layers a shaping material onto a target.

FIG. 5 is a view illustrating a shaping layer formed by the three-dimensional shaping apparatus according to the present embodiment by layering a shaping material on the target.

FIG. 6 is a diagram illustrating a measurement result of peel strength of a shaped product formed by using the three-dimensional shaping apparatus according to the present embodiment.

FIG. 7 is a diagram illustrating a measurement result of peel strength of a shaped product formed by using the three-dimensional shaping apparatus according to the present embodiment.

FIG. 8 is a diagram illustrating a measurement result of peel strength of a shaped product formed by using the three-dimensional shaping apparatus according to the present embodiment.

FIG. 9 is a diagram illustrating a measurement result of peel strength of a shaped product formed by using the three-dimensional shaping apparatus according to the present embodiment.

FIG. 10 is a diagram illustrating a measurement result of peel strength of a shaped product formed by the three-dimensional shaping apparatus according to the present embodiment.

FIG. 11 is a diagram illustrating a measurement result of peel strength of a shaped product formed by the three-dimensional shaping apparatus according to the present embodiment.

FIG. 12 is a schematic view of a variant of the three-dimensional shaping apparatus according to the present embodiment.

FIG. 13 is a block diagram illustrating a hardware configuration of the variant of the three-dimensional shaping apparatus according to the present embodiment.

FIG. 14 is a diagram illustrating a method for forming an integrated sheet using the three-dimensional shaping apparatus according to the present embodiment.

FIG. 15 is a diagram illustrating a method for forming an integrated sheet using the three-dimensional shaping apparatus according to the present embodiment.

FIG. 16 is a view illustrating an integrated sheet formed by using the three-dimensional shaping apparatus according to the present embodiment.

FIG. 17 is a view illustrating an integrated sheet formed by using the three-dimensional shaping apparatus according to the present embodiment.

FIG. 18 is a view illustrating a method for forming an integrated sheet formed by using the three-dimensional shaping apparatus according to the present embodiment.

FIG. 19 is a view illustrating a method for forming an integrated sheet formed by using the three-dimensional shaping apparatus according to the present embodiment.

FIG. 20 is a view illustrating a result of a deodorizing effect test performed on an integrated sheet formed using the three-dimensional shaping apparatus according to the present embodiment.

FIG. 21 is a view illustrating a result of a deodorizing effect test performed on an integrated sheet formed using the three-dimensional shaping apparatus according to the present embodiment.

FIG. 22 is a view illustrating a result of a deodorizing effect test performed on an integrated sheet formed using the three-dimensional shaping apparatus according to the present embodiment.

FIG. 23 is a view illustrating a result of a deodorizing effect test performed on an integrated sheet formed using the three-dimensional shaping apparatus according to the present embodiment.

FIG. 24 is a diagram illustrating a result of a washing resistance test performed on an integrated sheet formed using the three-dimensional shaping apparatus according to the present embodiment.

### DETAILED DESCRIPTION OF THE PREFERRED EMBODIMENTS

According to the present embodiment, it is possible to obtain a shaped product having a high adhesion between the shaping material and the target. Hereinafter, a mode for carrying out the present invention will be described with reference to the drawings. In the following description, the same elements depicted in the drawings may be denoted by the same reference numerals and overlapping descriptions may be omitted.

Hereinafter, a three-dimensional shaping apparatus 1 according to a present embodiment will be described in detail with reference to the accompanying drawings. It should be noted that the present invention is not limited to the present embodiment.

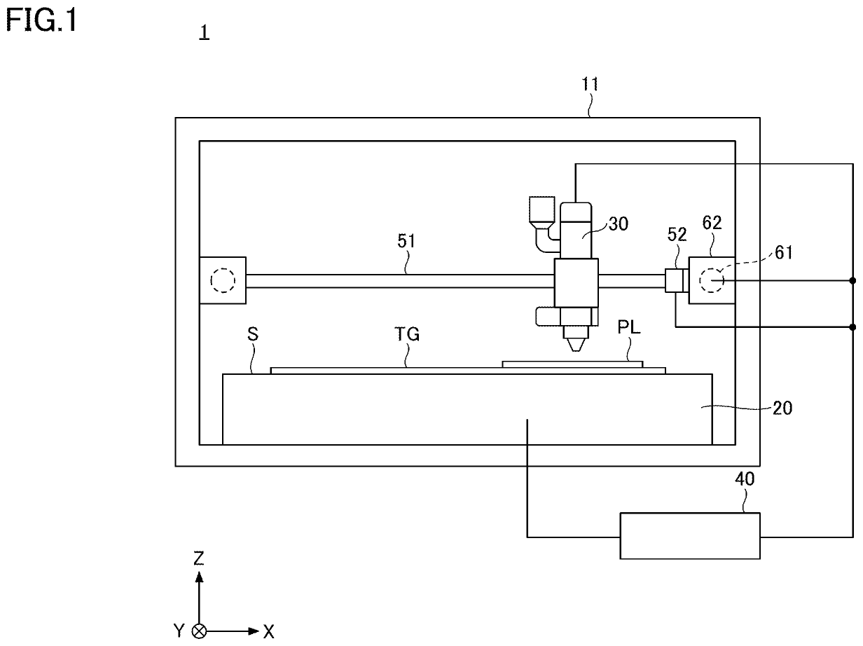

FIG. 1 depicts an overview of the three-dimensional shaping apparatus 1 according to the present embodiment. The horizontal direction in FIG. 1 is the X-axis direction, the depth direction is the Y-axis direction, and the vertical direction is the Z-axis direction.

The three-dimensional shaping apparatus 1 includes a shaping stage 20 and an extrusion device 30 inside a housing 11. The three-dimensional shaping apparatus also includes a control device 40.

The shaping stage 20 is a stage on which a target TG is placed. In the present embodiment, the target TG is a fabric or is a sheet in form of a net. The shaping stage 20 is configured to move a placement surface S in the Z-axis direction. By moving the placement surface S of the shaping stage 20 in the Z direction, the position of the shaping stage 20 in the height direction with respect to the extrusion device 30 can be adjusted. In the present embodiment, the distance between the target TG and a discharger (a nozzle end) for discharging a shaping material is adjusted by a processor. The adjustment of the distance is controlled based on a characteristic value of the target TG, and the processor may be a part of the control device 40 or may be replaced by a controller that is used to manually adjust the distance.

The extrusion device 30 extrudes a shaping material onto the target TG placed on the shaping stage 20 and layers a shaping layer PL. The extrusion device 30 is movably held by an X-axis drive shaft 51 extending in the X-axis direction. When an X-axis drive motor 52 rotates the X-axis drive shaft 51, the extrusion device 30 moves in the X-axis direction. The X-axis drive motor 52 is movably held by a Y-axis drive shaft 61 extending in the Y-axis direction. When the Y-axis drive shaft 61 rotates by the Y-axis drive motor 62, the X-axis drive motor 52 moves in the Y-axis direction. As the X-axis drive motor 52 moves in the Y-axis direction, the extrusion device 30 also moves in the Y-axis direction. The X-axis drive shaft 51, the X-axis drive motor 52, the Y-axis drive shaft 61, and the Y-axis drive motor 62 allow the extrusion device 30 to move in the X-axis direction and in the Y-axis direction.

In the three-dimensional shaping apparatus 1 according to the present embodiment, the shaping stage 20 moves in the Z-axis direction and the extrusion device 30 moves in the X-axis direction and the Y-axis direction. However, the movement method is not limited to this method, as long as the shaping stage 20 and the extrusion device 30 move relative to each other, and a different movement method may be appropriately employed.

Next, the extrusion device 30 will be described.

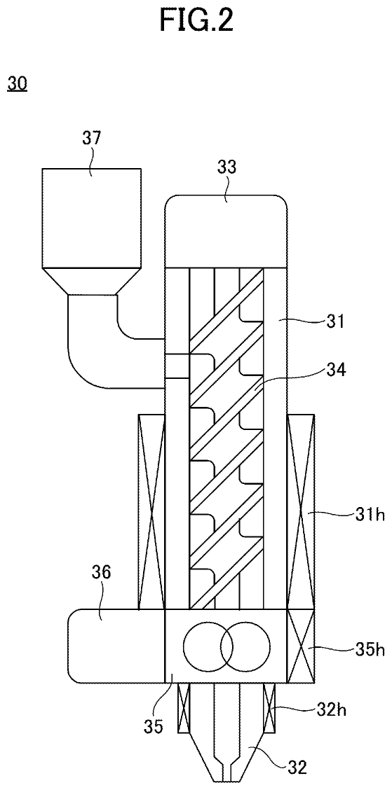

FIG. 2 is a partial cross-sectional view depicting an internal structure of the extrusion device 30 of the three-dimensional shaping apparatus 1 according to the present embodiment. The extrusion device 30 includes a cylinder 31 positioned perpendicular to the shaping stage 20. In FIG. 2, the cylinder 31 is depicted by a cross-sectional view taken along a plane that includes a central axis of the cylinder 31. The extrusion device 30 includes a shaping nozzle 32 at a lower end of the cylinder 31. In FIG. 2, a cross-sectional view taken along a plane that includes the central axis of the shaping nozzle 32 is depicted. The extrusion device 30 includes a screw 34 which is rotated by a screw motor 33 within the cylinder 31. The screw 34 is used to supply a shaping material after being molten from a pelletized shaping material (a resin material) supplied from a hopper 37, which will be described later, and supplies the molten shaping material to the shaping nozzle 32. The extrusion device 30 includes a cylinder heater 31h for heating the interior of the cylinder 31 on a peripheral wall surface of the cylinder 31. In FIG. 2, the heater is depicted by crossing lines. The extrusion device 30 includes the hopper 37 above the cylinder 31 for supplying a shaping material (a resin material) to the interior of the cylinder 31. The hopper 37 stores a pelletized shaping material (resin material). The extrusion device 30 further includes a nozzle heater 32h for keeping the temperature of the molten resin constant in the shaping nozzle 32.

The extrusion device 30 may also include a gear pump 35 at a distal end of the screw 34. The gear pump 35 delivers a shaping material (a resin material) to the shaping nozzle 32 by rotation of a gear by a gear-pump motor 36. As a result of the gear pump 35 being used, the rotation of the gear of the gear pump 35 is controlled by the gear-pump motor 36, and a molten resin is fed by the gear pump 35. Therefore, clogging in the nozzle is not likely to occur, and it is possible to effectively prevent dripping of a resin having low viscosity. The gear pump 35 includes a gear-pump heater 35h to keep the temperature of a shaping material (a resin material) within the gear pump 35 constant.

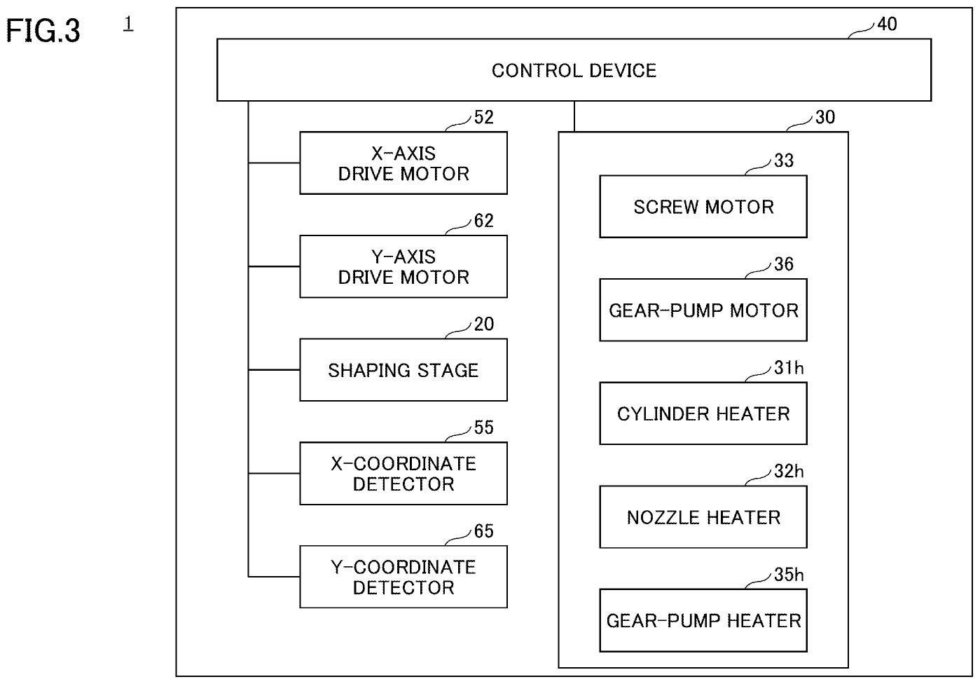

FIG. 3 is a block diagram illustrating a hardware configuration of the three-dimensional shaping apparatus 1 according to the present embodiment. The three-dimensional shaping apparatus 1 includes the control device 40. The control device 40 is configured as a microcomputer including a micro processing unit (MPU), a memory, various circuits, and the like. As depicted in FIG. 3, the control device 40 is electrically connected to various elements.

The three-dimensional shaping apparatus 1 includes an X-coordinate detector 55 for detecting a X-axis position of the extrusion device 30. A detection result of the X-coordinate detector 55 is sent to the control device 40. The control device 40 drives the X-axis drive motor 52 based on the detection result of the X-coordinate detector 55. The control device 40 drives the X-axis drive motor 52 to move the extrusion device 30, and hence the shaping nozzle 32, to a required X-axis position.

The three-dimensional shaping apparatus 1 includes a Y-coordinate detector 65 for detecting a Y-axis position of the extrusion device 30. A detection result of the Y-coordinate detector 65 is sent to the control device 40. The control device 40 drives the Y-axis drive motor 62 based on the detection result of the Y-coordinate detector 65. The control device 40 drives the Y-axis drive motor 62 to move the extrusion device 30, and hence the shaping nozzle 32, to a required Y-axis position.

The control device 40 controls the shaping stage 20 to move the placement surface S to a required Z-axis position.

The control device 40 moves the relative three-dimensional position between the extrusion device 30 and the shaping stage 20 to a required three-dimensional position by controlling movement of the extrusion device 30 and shaping stage 20.

Additionally, the control device 40 controls the screw motor 33 and the gear-pump motor 36 of the extrusion device 30 to extrude a required amount of a shaping material. When extruding a shaping material, the cylinder heater 31h, the nozzle heater 32h, and the gear-pump heater 35h are controlled to cause the shaping material to have a required temperature.

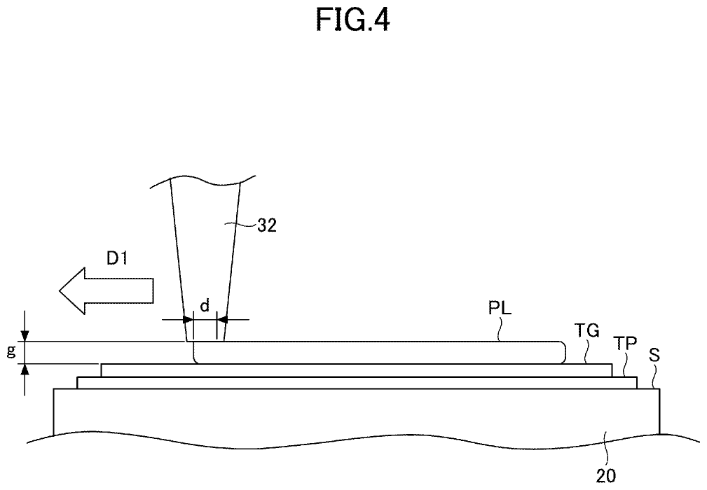

FIG. 4 is a diagram illustrating a state in which the three-dimensional shaping apparatus 1 according to the present embodiment layers a shaping material onto a target TG. A fabric or a sheet in form of a net, which is a target TG, is fastened to the placement surface S of the shaping stage 20 by a tape TP or the like. A shaping material is discharged by the shaping nozzle 32 of the extrusion device 30 onto the target TG. When a shaping material is discharged, a gap g is provided between the shaping nozzle 32 and the target TG. The shaping nozzle 32 having a nozzle diameter d moves in a direction of an arrow D1 at a predetermined constant nozzle speed and discharges a molten shaping material to layer a shaping layer PL. The shaping material is discharged to form a shaped product.

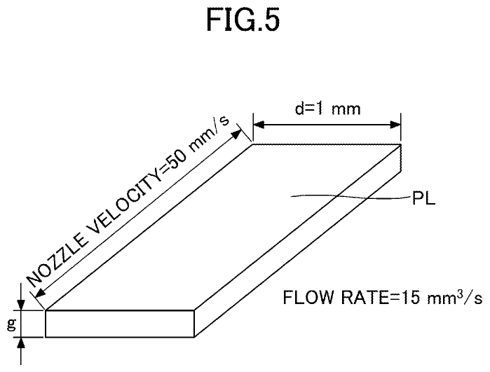

FIG. 5 is a diagram illustrating a shaping layer PL formed by the three-dimensional shaping apparatus 1 according to the present embodiment by layering a shaping material onto the target TG. FIG. 5 schematically depicts one piece of a shaping layer PL formed in 1 second by the three-dimensional shaping apparatus 1.

Relationships between a flow rate FR and a gap between a nozzle end and a shaping stage in a typical three-dimensional shaping apparatus will now be described. The flow rate FR is a volume of a resin discharged from the nozzle in 1 second. A unit of the flow rate is mm³/s (cubic millimeters per second). By dividing the flow rate by a nozzle velocity v (unit: mm/s (millimeters per second)) which is a linear velocity of the nozzle, and also, dividing by a nozzle diameter d (unit: mm (millimeters)), an optimum gap g0, which is an optimum gap for layering a shaping layer PL, can be calculated. That is, the optimum gap g0 can be calculated by Formula 1.

g0=FR/Vd Formula 1

In an experiment of layering a shaping layer PL depicted in FIG. 5, the nozzle diameter d was set as 1 mm, the nozzle velocity v was set as 50 mm/s, and the flow rate FR was set as 15 mm³/s. Under these conditions, the optimum gap g0 for layering a shaping layer PL is 0.3 mm.

Here, a case in which the target TG is a fabric will be described. However, advantageous effects according to the embodiment and variant of the present invention can be obtained similarly also when a sheet in form of a net is used instead. When forming a three-dimensional product on a fabric, it has been difficult to form the product on the fabric because the fabric may have wrinkled or creased, for example. In addition, there has been a problem that the fabric may come off soon after being applied due to there being low adhesion between the fabric and the three-dimensional product. The three-dimensional product means a finished product formed by discharging a shaping material and layering multiple layers together. Thus mutually layered multiple shaping layers (an aggregate of shaping layers) may be simply called a shaped product. Especially because of characteristics of forming a three-dimensional product onto a fabric, adhesiveness such that the product does not easily peels off even when washed is required. The inventors have studied for determine a value to which the gap described above for laying a shaping material onto a fabric should be adjusted. In this regard, it has been presumed that a porosity, which is a characteristic value of a fabric, is closely related to a desired gap, and relationships between a porosity and a result of a peel test in which a shaped product was peeled off a fabric were obtained.

First, a porosity of a fabric will now be described. For obtaining a porosity, see “3.1 Porosity of Silk Fabric” in “Stratification of Fabric using Porosity” in Fiber Engineering (Vol. 40, No. 2 (1987)) published by the Textile Machinery Society of Japan, and so forth, have been used. A porosity is used to determine a fabric density. In calculating a porosity, vertical and horizontal densities of a fabric are converted to densities of a fabric made of a raw silk, respectively, in order to evaluate a denier difference and a density difference on the same basis. Thus obtained densities through conversion will be referred to as converted densities. A porosity (unit: %) will be obtained using the converted densities.

Formulas 2-4 depict formulas for a porosity PS of a fabric. Kᵤₚ denotes a longitudinal cover factor, K_{Wf} denotes a horizontal cover factor, Nᵤₚ denotes a converted vertical density (unit: fibers/cm), N_{uf} denotes a converted horizontal density (unit: fibers/cm), Kₘₐₓ denotes the maximum cover factor, and α denotes a conversion factor.

$$\begin{matrix}\begin{matrix}PS = ( \frac{{K}_{max} - {K}_{up}}{{K}_{max}} ) ( \frac{{K}_{max} - {K}_{wf}}{{K}_{max}} ) \times 100 & Formula 2\end{matrix} \\ \begin{matrix}{K}_{up} = {N}_{up} \times \sqrt{α} & Formula 3\end{matrix} \\ \begin{matrix}{K}_{wf} = {N}_{wf} \times \sqrt{α} & Formula 4\end{matrix}\end{matrix}$$

Table 1 depicts the maximum cover factor Kₘₐₓ and the conversion factor α for each fabric material

TABLE 1

| | maximum cover | conversion |
|---|---|---|
| material | factor Kmax | factor α |
| silk | 940 | 63 |
| polyester | 988 | 60 |
| nylon | 898 | 60 |
| acetate | 966 | 60 |
| rayon | 1030 | 60 |

Using Formulas 2 to 4, a porosity of each fabric that was used in the present experiment is obtained as depicted in Table 2.

TABLE 2

| sample | | | converted density (fibers/cm) | | porosity | thickness |
|---|---|---|---|---|---|---|
| number | material | product name | vertical | horizontal | (%) | (mm) |
| 1 | silk | satin crepe | 90 | 38 | 16 | 0.4 |
| 2 | polyester | voile | 37 | 36 | 52 | 0.55 |
| 3 | | crepe de Chine | 60 | 40 | 36 | 0.5 |
| 4 | nylon | umbellar cloth | 88 | 42 | 16 | 0.5 |
| | | (plain weave) | | | | |
| 5 | acetate | foil | 44 | 39 | 45 | 0.6 |
| | | (plain weave) | | | | |
| 6 | | taffeta | 81 | 47 | 22 | 0.4 |
| 7 | rayon | shirt cloth | 66 | 46 | 33 | 0.65 |

Two types of discharge resins were used in the experimental method in the present experiment. One discharge resin is an acrylonitrile butadiene styrene (ABS) resin. An ABS resin has a high longitudinal elastic modulus (2-3 GPa). The ABS resin is, for example, STYLAC (registered trademark) manufactured by Asahi Kasei Corporation. Another discharge resin is a styrene thermoplastic elastomer. A styrene thermoplastic elastomer has a low longitudinal elastic modulus (3.5 MPa). The styrene thermoplastic elastomer is, for example, TEFABLOC (registered trademark) manufactured by Mitsubishi Chemical Corporation.

A longitudinal elastic modulus is also called a Young's modulus and is a slope with respect to a stress in a tensile test expressed by the following formula:

σ=Eε

In the formula, σ denotes a tensile stress, E denotes a longitudinal elastic modulus, and E denotes a strain.

For each fabric depicted in Table 2, shaped products that were rectangles each having a size of 1 cm by 5 cm were formed where the gap was changed. Then, a peel test was performed to measure corresponding adhesive strengths.

An adhesion between a resin discharged to a fabric and the fabric is measured by a peel test depicted below. A first layer was formed by applying a material in the X-axis direction to each fabric with the sample number depicted in Table 2, and a second layer was formed by applying the material in the Y-axis direction, thereby forming two layers of shaped products that are rectangles each with a size of 1 cm by 5 cm. Then, the formed product was slightly removed from the short side end and was held by a film chuck. The product was then lifted by the film chuck in a vertical direction at a load velocity of 300 mm/min at an angle of 90 degrees relative to the product. A force gauge, a load cell, and the film chuck manufactured by Imada Co., Ltd. were used for the test.

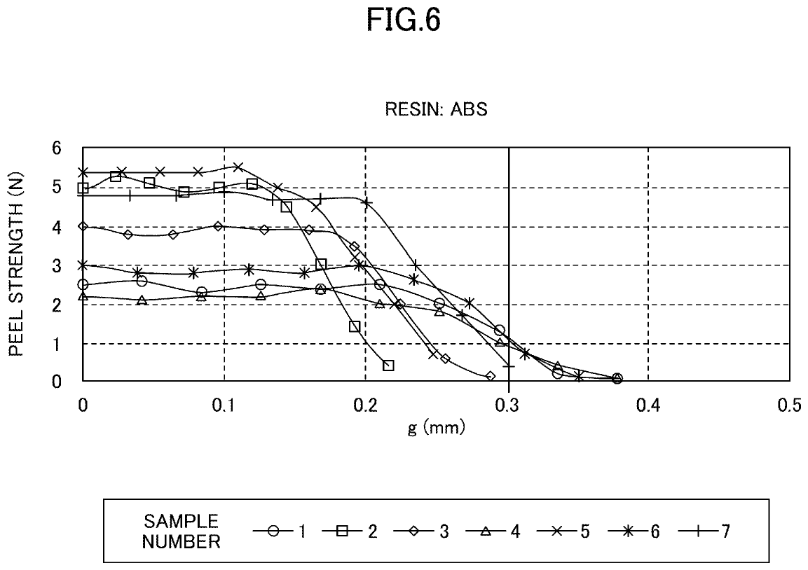

In the present test, a pellet-type three-dimensional shaping apparatus depicted in FIG. 1 was used. The nozzle temperature at discharge of both resins was 240° C., and the temperature of the shaping stage was not adjusted. FIG. 6 is a diagram illustrating a measurement result of the peel strengths of the shaped products formed by the three-dimensional shaping apparatus 1 according to the present embodiment. FIG. 6 is a result of layering the ABS resin to the fabric.

In a case of discharging directly onto the shaping stage 20, the optimum gap g0 described above may be set for layering. However, when layering onto a fabric, as depicted in FIG. 6, a higher peel test strength (bonding strength) is obtained with a gap smaller than the calculated optimum gap g0 (here 0.3 mm). However, an optimum gap range where a high bonding strength is obtained depends on a fabric type, and such an optimum gap range cannot be determined unambiguously.

Therefore, the inventors of the present application have been diligently studying in order to determine an optimum gap unambiguously, and have found that an optimum gap can be unambiguously determined for any type of fabric by converting the value of the gap g using a porosity of the type of fabric. Specifically, the gap g depicted in FIG. 4 and so forth should be converted into a converted gap g1 based on a porosity of a type of fabric as depicted in Formula 5.

$$ℊ 1 = \frac{ℊ}{\frac{100 - PS}{100}} \qquad Formula 5$$

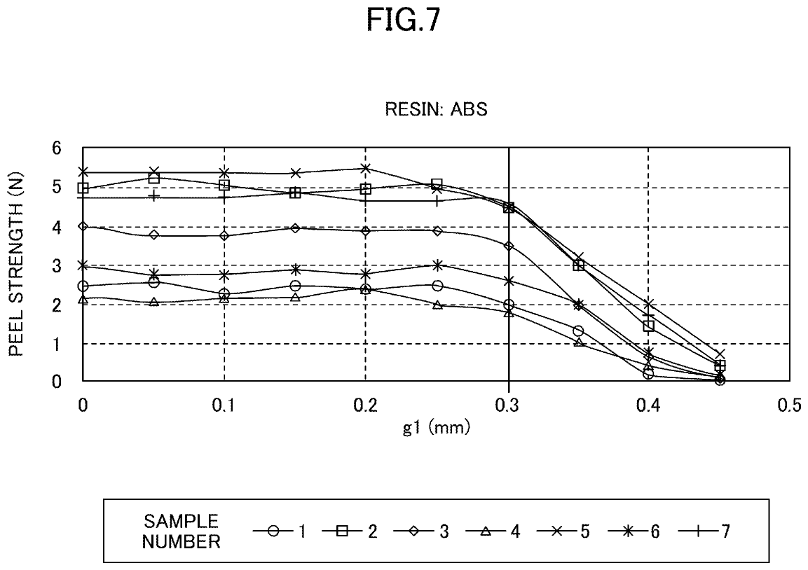

FIG. 7 is a diagram for explaining a measurement result of a peel strength with respect to the three-dimensional shaping apparatus 1 according to the present embodiment when the gap g is converted into the converted gap g1. In FIG. 7, when the gap g is converted to the converted gap g1, the peel strength is almost constant in a range where the converted gap g1 is smaller than the optimum gap g0 (0.3 mm). That is, for the fabrics having the sample numbers 1 to 7, as a result of the gaps g being converted based on the porosities of the fabrics, specifically, as a result of the gaps g being converted according to Formula 5, the converted gaps with which the bonding strengths sharply increase can be determined. Then, it was found that if the gap g satisfies the conditions defined by Formula 6, a high adhesive shaped product is obtained.

$$ℊ \leq \frac{100 - PS}{100} ℊ0 = \frac{100 - PS}{100} \times \frac{FR}{vd} \qquad Formula 6$$

In addition, when the target is a fabric, the nozzle can be brought closer to the fabric so that the nozzle comes into contact with the fabric. Further, a resin can be discharged from the nozzle even when the nozzle height is further reduced from the height at which the nozzle contacts the fabric. Hereinafter, a case where the nozzle height is further reduced than the height of being in contact with the fabric will be described.

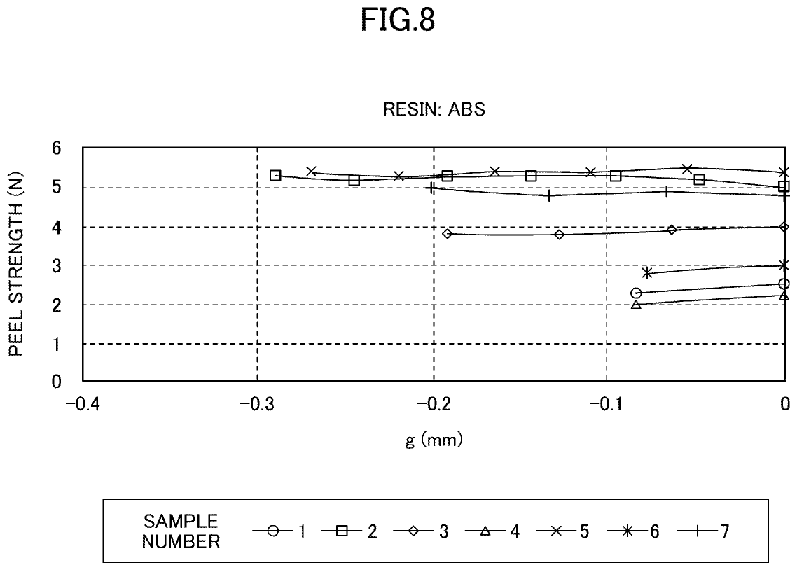

FIG. 8 is a diagram illustrating a measurement result of peel strength when the nozzle of the three-dimensional shaping apparatus 1 according to the present embodiment is used for layering in contact with a fabric. In FIG. 8, the height at which the nozzle is in contact with the fabric is referred to as 0 mm. Accordingly, in the measurement result of FIG. 8, the gap g is negative because the nozzle is in contact with the fabric.

In FIG. 8, the lower limit position of the nozzle to the minus side of the gap g (the gaps that were able to be measured, in FIG. 8) is irregularly different for each fabric. The gap at this lower limit position is referred to as a critical nozzle gap g_{L}. When the critical nozzle gap g_{L} is exceeded, a defect such as a nozzle discharge defect or straying from a required discharge width occur in all fabrics. Thus, the inventors of the present application found that the critical nozzle gap g_{L} can be determined by calculating a gap g2 based on Formula 7. Note that t denotes the thickness of a fabric.

$$ℊ2 = - t \frac{PS}{100} \qquad Formula 7$$

Table 3 depicts the critical nozzle gap g_{L} and the calculated gap g2 for each sample number. The ratio between the critical nozzle gap g_{L} and the calculated gap g2 is also depicted in Table 3. The ratio of the critical nozzle gap g to the calculated gap g2 was approximately 1. In other words, it was found that the nozzle position of the lower limit can be calculated by using Formula 7.

TABLE 3

| sample | | | porosity | thickness | g_{L} | g2 | |
|---|---|---|---|---|---|---|---|
| number | material | product name | (%) | (mm) | (mm) | (mm) | g_{L}/g2 |
| 1 | silk | satin crepe | 16 | 0.4 | −0.07 | −0.06 | 1.16 |
| 2 | polyester | voile | 52 | 0.55 | −0.29 | −0.29 | 1.01 |
| 3 | | crepe de Chine | 36 | 0.5 | −0.19 | −0.18 | 1.07 |
| 4 | nylon | umbellar cloth | 16 | 0.5 | −0.08 | −0.08 | 1.05 |
| | | (plain weave) | | | | | |
| 5 | acetate | foil | 45 | 0.6 | −0.27 | −0.27 | 1.00 |
| | | (plain weave) | | | | | |
| 6 | | taffeta | 22 | 0.4 | −0.08 | −0.09 | 0.93 |
| 7 | rayon | shirt cloth | 33 | 0.65 | −0.20 | −0.21 | 0.94 |

Accordingly, it was found that if the gap g satisfies the conditions defined by Formula 8, it is possible to form a shaped product without causing any defect.

$$- t \frac{PS}{100} \leq ℊ \qquad Formula 8$$

Next, in order to study whether the embodiment and variant of the present invention are applicable to various resins, the styrene thermoplastic elastomer with a low longitudinal elastic modulus (3.5 MPa) was tested instead of the ABS resin with a high longitudinal elastic modulus (2-3 GPa).

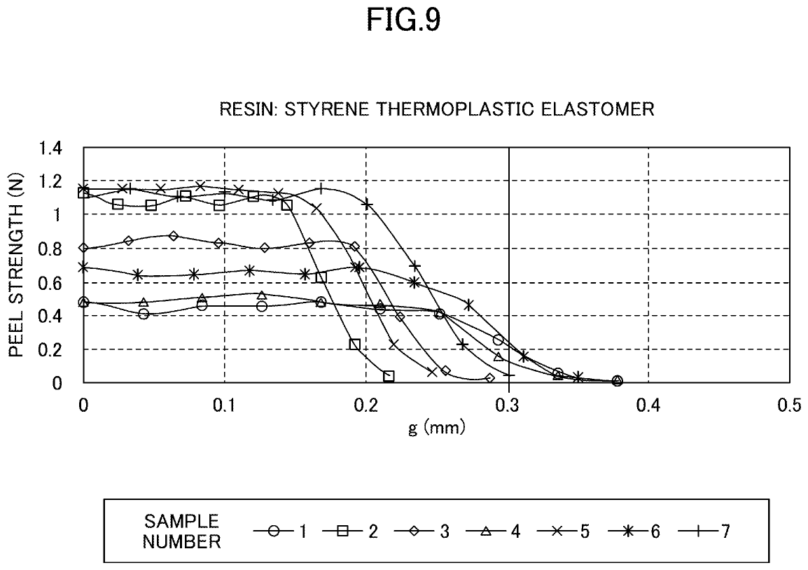

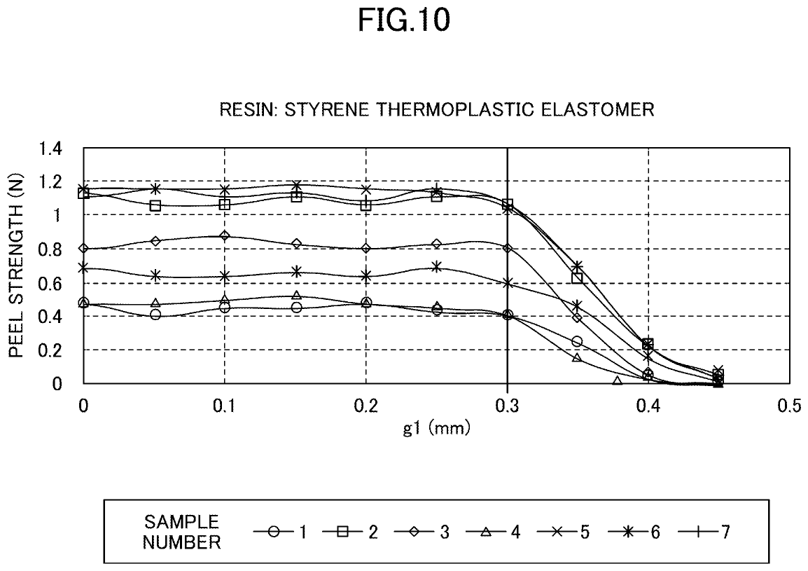

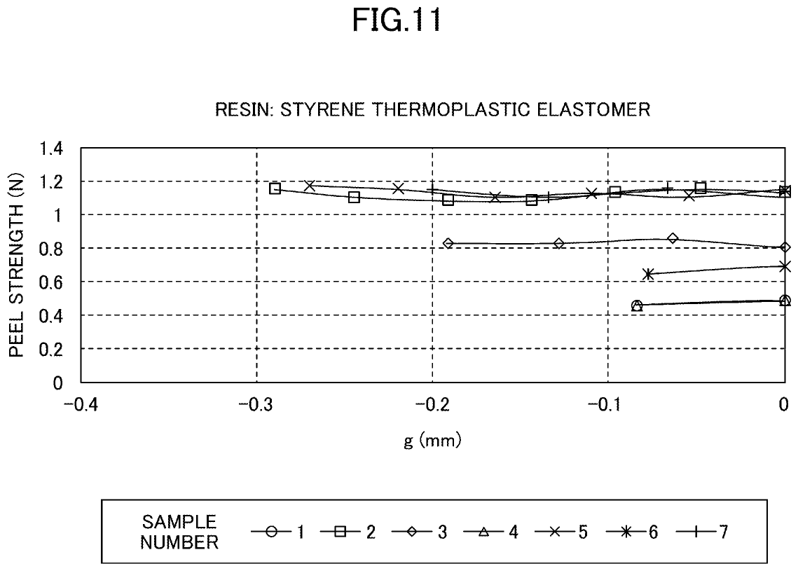

FIGS. 9 and 10 are diagrams illustrating measurement results of peel strengths of shaped products formed using the three-dimensional shaping apparatus 1 according to the present embodiment. FIG. 11 is a diagram illustrating a measurement result of a peel strength of a shaped product formed when the nozzle of the three-dimensional shaping apparatus 1 according to the present embodiment is in contact with a fabric during a layering process. It can be seen that, even with the resin of low longitudinal elastic modulus, a peel test strength (adhesion strength) is higher in a range of the gap smaller than the optimum gap calculated as in FIG. 7. However, depending on a type of fabric, the optimum gap range with high adhesive strength varied, and the optimum gap range was not be able to be determined unambiguously.

The inventors of the present application diligently studied for unambiguously obtaining the gap and found that, also for the styrene thermoplastic elastomer, as in the case using the ABS resin, it is possible to obtain the optimal gap value unambiguously for any fabric by converting the value of the gap g using the porosity of the fabric. That is, it was found that, using the calculations based on Formula 5, the converted gaps at which sharp increases in adhesive strengths occur can be made approximately the same for the respective fabrics depicted in the graph of FIG. 10.

In FIG. 11, as in FIG. 8, the lower limit positions of the nozzle to the minus side of the gap g (the gaps that were able to be measured, in FIG. 11) are irregularly different for the respective fabrics. The gap at the lower limit position is referred to as a critical nozzle gap g_{L}. Table 4 depicts the critical nozzle gap g_{L} and the calculated gap g2 for each sample number. The ratio between the critical nozzle gap g_{L} and the calculated gap g2 is also depicted in Table 4. The ratio of the critical nozzle gap g_{L} to the calculated gap g2 was approximately 1. That is, it was found that the critical nozzle gap g_{L} can be determined by calculating the gap g2 based on Formula 7.

TABLE 4

| sample | | | porosity | thickness | g_{L} | g2 | |
|---|---|---|---|---|---|---|---|
| number | material | product name | (%) | (mm) | (mm) | (mm) | g_{L}/g2 |
| 1 | silk | satin crepe | 16 | 0.4 | −0.07 | −0.06 | 1.05 |
| 2 | polyester | voile | 52 | 0.55 | −0.29 | −0.29 | 1.01 |
| 3 | | crepe de Chine | 36 | 0.5 | −0.19 | −0.18 | 1.03 |
| 4 | nylon | umbellar cloth | 16 | 0.5 | −0.08 | −0.08 | 1.05 |
| | | (plain weave) | | | | | |
| 5 | acetate | foil | 45 | 0.6 | −0.25 | −0.27 | 0.93 |
| | | (plain weave) | | | | | |
| 6 | | taffeta | 22 | 0.4 | −0.10 | −0.09 | 1.14 |
| 7 | rayon | shirt cloth | 33 | 0.65 | −0.22 | −0.21 | 1.03 |

In other words, it was found that also for the styrene thermoplastic elastomer having a low longitudinal elastic modulus, by using a gap smaller than the converted value obtained by the same conversion as the conversion used for the ABS resin having a high longitudinal elastic modulus, a shaped product having a high adhesive strength can be obtained. In other words, the inventors have been able to prove that the same or similar result can be obtained for a resin with a longitudinal elastic modulus that is different nearly by 1000 times.

However, because the longitudinal elastic modulus of a styrene thermoplastic elastomer is too low compared to an ABS resin, peel strength tends to be smaller than peel strength of the ABS resin.

Based on the above-described results, the control device 40 controls the distance between a target TG and the shaping nozzle 32, i.e., controls the gap g based on a characteristic value of the target TG. Specifically, the control device 40 controls the positioning of the target TG and the shaping nozzle 32 in such a manner that the gap g satisfies the conditions defined by Formulas 6 and 8, which include at least the thickness and the porosity of the target TG as the characteristic values of the target TG. Further, the three-dimensional shaping apparatus 1 according to the present embodiment is used to perform a three-dimensional shaping method in which a three-dimensional product is formed on a target TG placed on the shaping stage 20 using a shaping material. The shaping nozzle 32 is an example of a discharger, the nozzle diameter is an example of an extending-end diameter, and the control device 40 is an example of the processor.

### Advantageous Effects

With the three-dimensional shaping apparatus 1 of the present embodiment, it is possible to obtain advantageous effects that adhesion between a fabric or a sheet in form of a net and a shaped product becomes remarkably higher.

In addition, according to the three-dimensional shaping apparatus 1 of the present embodiment, a soft resin having a longitudinal elastic modulus of not more than 5 MPa, a resin having a glass transition temperature Tg of not more than 40° C., or a shape memory polymer can be used to form a shaped product on a fabric or a sheet in form of a net.

With regard to the embodiment and variant of the present invention aiming to allow formation of a shaped product directly onto a fabric or onto a sheet in form of a net, particularly for a case where a shaped product is used in a manner of being directly in contact with a human skin, there is a desire to form a shaped product by melting and discharging a soft resin.

However, in a fused deposition modeling (FDM) method using a filament, a filament of a soft resin with a longitudinal elastic modulus of 5 MPa or less, and discharge the same were unable to be formed. The reason is that, when a soft filament with a longitudinal elastic modulus of 5 MPa or less is extruded using a gear, a defect such as buckling occurs.

A shape memory polymer may be used as a material suitable for the embodiment and variant of the present invention intended to form a shaped product using a resin on a fabric or on a sheet in form of a net.

A shape memory polymer is a polymer such that a shaped product restores its original shape when heated to above a certain temperature, even after a force is applied to the shaped product which has been thus deformed after being molded using the polymer. Major shape memory polymers include polynorbornene, trans-polyisoprene, styrene-butadiene copolymer, polyurethane, and the like.

As described above, when performing a method for forming a shaped product using a resin directly on a fabric or on a sheet in form of a net, which is an object of the embodiment and variant of the present invention, it is desirable that the shaped product fits to human body as a result of, thanks to a shape memory function, the original shape being returned to at a temperature near the human body temperature. Further, as a characteristic of a shape memory polymer, water vapor transmission is increased at a temperature above the glass transition temperature (Tg). In other words, because becoming sweaty can be thus prevented even if the product is used in direct contact with a human skin, it is easy to obtain comfortable wearing feeling, and thus, a shape memory polymer can be said to be a desirable material.

Further, in the present embodiment and variant of the present invention aiming at optimizing the above-described gap value for a fabric so as to be able to form a shaped product directly on the fabric, it is desired to form a shaped product by melting and discharging a soft resin, particularly when the shaped product is used in a manner of being directly in contact with a human skin. If a resin having a glass transition temperature (Tg) of 40° C. or less is used as a shape memory polymer for forming a shaped product, the resin will become soft at a human body temperature and feel gentle to the human skin. In addition, the resin returns to an original shape, a memory of which is held in the resin, at a temperature of Tg or higher. Therefore, the resin is suitable for use in a underwear or clothing requiring even better body-fitting properties. In the past, however, a shape memory polymer with a low Tg became too soft at a room temperature, and thus, a stable shaped product was not be able to be obtained by a FDM method using a filament.

Therefore, the extrusion device having the cylinder, the screw, and the nozzle is used to heat and melt a resin material fed into the cylinder by a heater provided in the cylinder. Thus, by using the extrusion device having the cylinder, the screw, and the nozzle, it is possible to form a shaped product on a fabric or on a sheet in form of a net using a soft resin having a longitudinal elastic modulus of 5 MPa or less, a resin having a glass transition temperature Tg of 40° C. or less, or a shape memory polymer.

Further, according to the three-dimensional shaping apparatus 1 of the present embodiment, it is possible to form a shaped product onto a target TG without causing the target TG to wrinkle or crease. In the three-dimensional shaping apparatus 1 according to the present embodiment, a target TG is attached onto the shaping stage using an adhesive tape or the like.

For example, as a method for fastening a fabric or a sheet in form of a net onto the shaping stage, there is a method of fastening the four corners of the fabric or of the sheet in form of a net using clips, a method of fastening the fabric or the sheet in form of a net by applying a tension to the fabric or to the sheet in form of a net using a roll, or the like.

### <Variant>

In the above description of the embodiment, a three-dimensional shaping apparatus using a pellet has been described. Hereinafter, a three-dimensional shaping apparatus using a resin filament wound around a reel will be described.

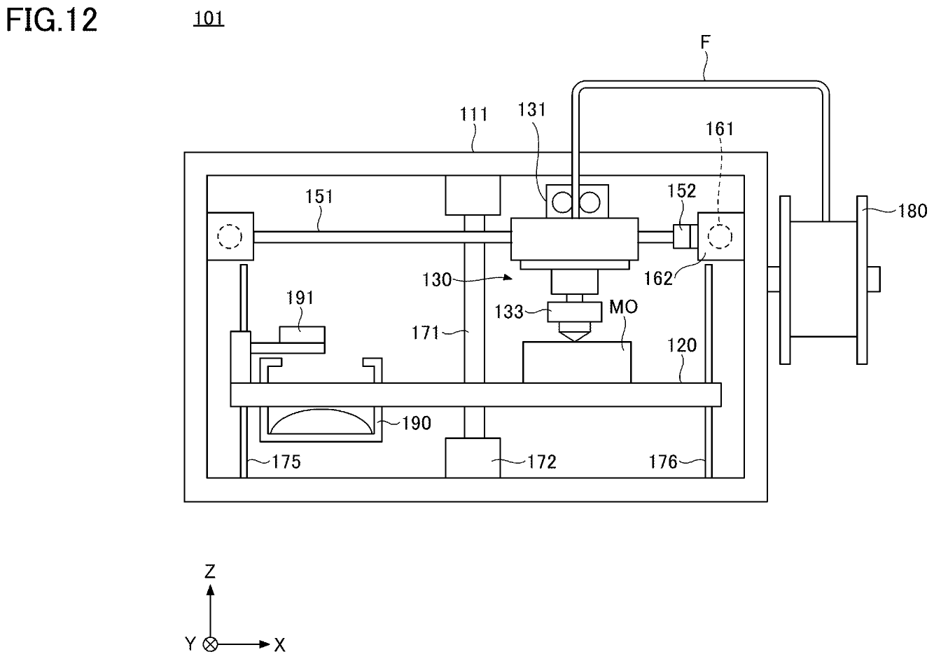

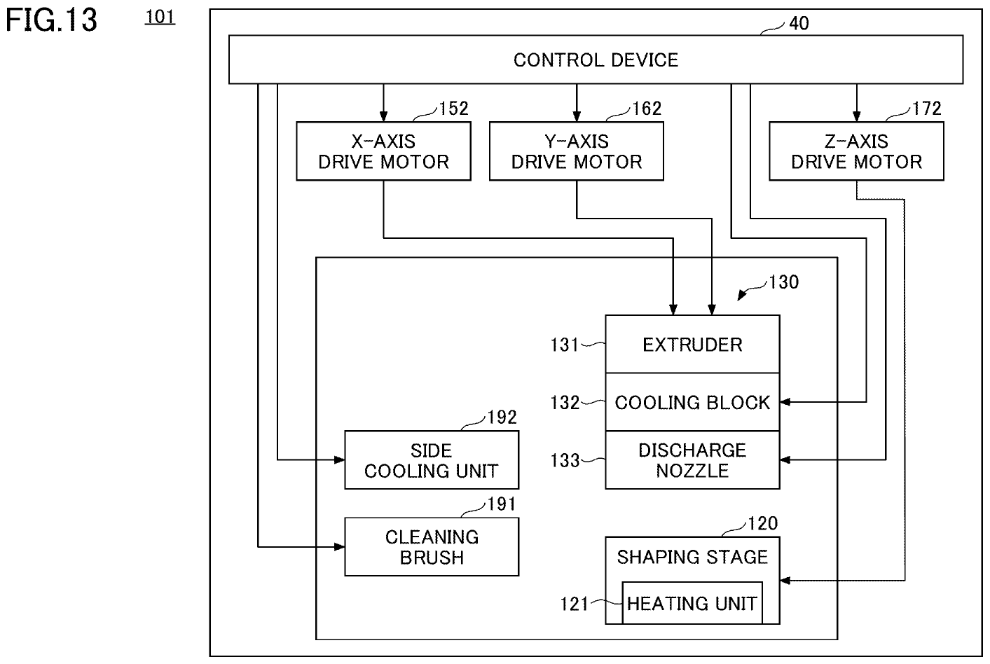

FIG. 12 depicts an overview of the three-dimensional shaping apparatus 101 that is a variant of the three-dimensional shaping apparatus 1 according to the present embodiment. FIG. 13 is a block diagram illustrating a hardware configuration of the three-dimensional shaping apparatus 101, which is the variant of the three-dimensional shaping apparatus 1 according to the present embodiment.

The three-dimensional shaping apparatus 101 of FIG. 12 is a three-dimensional shaping apparatus using a FDM method in which a resin in form of a filament wound around a reel 180 is molten and is applied in a molten state.

The three-dimensional shaping apparatus 101 includes a housing 111, a shaping stage 120, a reel 180 wound with a filament F, and a discharge module 130.

The three-dimensional shaping apparatus 101 includes a cooling block 132 and a heating block. The cooling block may be provided on top of the heating block. As a result, the filament F may be cooled by the cooling block 132 prior to being heated and molten by the heating block. The cooling block 132 includes a cooling source (not depicted) to cool the filament F. By previously cooling the filament F using the cooling block 132, it is possible to prevent the filament F from being heated and molten by the heat generated by the heating block before the filament F reaches the heating block. As a result, backflow of the molten filament F into the top of the discharge module 130, increase in the resistance against the extrusion of the molten filament F, or clogging in the extruder 131 due to solidification of the molten filament F can be prevented.

The heating block includes a heater (not depicted) as a heat source and a temperature sensor (e.g., a thermocouple, etc.) not depicted for detecting a temperature for controlling the heater. The heating block heats and melts the resin fed to the discharge module 130 through the extruder 131 and feeds the molten resin to the discharge nozzle 133.

The discharge nozzle 133 provided at the lower end of the discharge module 130 discharges the molten or semi-molten resin supplied from the heating block onto the shaping stage 120 in a manner of extruding the linearly extending resin. The discharged resin is cooled and solidified so that a layer of a required shape is layered. The discharge nozzle 133 repeatedly discharges the resin in the molten state or the resin in the semi-molten state in a manner of extruding the linearly extending resin onto the already layered layers so that a new layer is layered, and thus, multiple layers are mutually layered. In this way, the three-dimensional shaping apparatus 101 forms a three-dimensional product on a fabric or on a sheet in form of a net to produce a combination product MO.

The discharge module 130 is movably held by a fastening member to an X-axis drive shaft 151 extending in a horizontal direction (the X-axis direction) of the three-dimensional shaping apparatus 101. The discharge module 130 can be moved in the horizontal direction (the X-axis direction) of the three-dimensional shaping apparatus 101 by a driving force of the X-axis drive motor 152.

The X-axis drive motor 152 is movably held along a Y-axis drive shaft 161 extending in a depth direction (the Y-axis direction) of the three-dimensional shaping apparatus 101. As the X-axis drive shaft 151 is moved together with the X-axis drive motor 152 along the Y-axis direction by the driving force of the Y-axis drive motor 162, the discharge module 130 moves in the Y-axis direction.

A Z-axis drive shaft 171 and guide shafts 175 and 176 pass through the shaping stage 120, and the shaping stage 120 is movably held along the Z-axis drive shaft extending in the vertical direction (in the Z-axis direction) of the three-dimensional shaping apparatus 101. The shaping stage 120 moves in the vertical direction (in the Z-axis direction) of the three-dimensional shaping apparatus 101 by the driving force of the Z-axis drive motor 172. The shaping stage 120 may be provided with a shaped product heating unit 121 configured to heat a target TG and a shaped product placed onto the target TG by laminating.

When the resin is molten and discharged repeatedly, a peripheral portion of the discharge nozzle 133 may become dirty with molten resin or the like over time. Therefore, a cleaning brush 191 provided in the three-dimensional shaping apparatus 101 is used to periodically clean the peripheral portion of the discharge nozzle 133, so that it is possible to prevent the filament from adhering to the front end of the discharge nozzle 133.

It is preferable that such a cleaning operation be performed before the temperature of the molten resin is completely lowered in order to prevent the adhesion. In this case, the cleaning brush is preferably made of a heat resistant member.

Powder generated through polishing during the cleaning operation may be collected in a dust box 190 provided in the three-dimensional shaping apparatus and discharged periodically, or a suction pathway may be provided to discharge the powder to the outside of the three-dimensional shaping apparatus 1.

The three-dimensional shaping apparatus 101 may also include a side cooling unit 192 for cooling the dust box 190.

It should be noted that the target TG on which a shaped product is formed may be a fabric (cloth). For example, a fabric using natural fibers or chemical fibers may be used. The target TG may also be a sheet in form of a net of resin, rubber, or fibers. As a specific shape of the mesh, any mesh shape such as a square shape, a triangle shape, a diamond shape, a honeycomb shape, or the like can be selected; and the mesh size can be determined at any size. The target TG is not limited to a cloth state of a fabric, and a shaped product may be formed also on a fabric (cloth) in a state of finished goods such as an underwear, shoes, clothing, etc. In addition, the target TG may be a leather or a mixture of fibers and a leather, or the like.

Three-dimensional shaping apparatuses according to embodiments of the present invention are not limited to the three-dimensional shaping apparatuses according to the present embodiment and variant, and may be any types of three-dimensional shaping apparatuses as long as the apparatuses form shaped products on fabrics or sheets in the form of nets. Also a form of a raw material of a shaping material is not limited to a pellet or a filament descried above, and any form of material may be used as long as the material can be used to form a shaped product on a fabric or on a sheet in form of a net.

Further, the discharger is not limited to the shaping nozzle 32 according to the embodiment or the discharge module 130 according to the variant of the present embodiment described above, and may be any unit configured to discharge a shaping material onto a fabric or onto a sheet in form of a net to form a shaped product.

### Example of Application

A product suitable for production using the three-dimensional shaping apparatus or the three-dimensional shaping method according to the present embodiment will be described.

### [Integrated Sheet]

An integrated sheet produced as a result of a shape memory polymer being laminated to form a shaped product on a fabric or on a sheet in form of a net using the three-dimensional shaping apparatus 1 according to the present embodiment will now be described. The integrated sheet of a present embodiment is promising for applications requiring a shape memory function, such as any applications requiring body-fitting properties.

As a specific example, a wig base that serves as a base of a wig produced using the three-dimensional shaping apparatus 1 according to the present embodiment will be described.

### (Wig Base)

People who have lost their hair due to illness or who suffer from thinning hair want wigs that fit the shapes of their head.

Japanese Patent No. 5016447 discloses a wig having hair implanted on a wig base. Further, there is disclosed also a wig in which a wig base includes a first net member in contact with a head and a second net member for implanting hair thereto, wherein the first net member and the second net member are connected together by entangling with the use of connecting knitting threads.

A wig is manufactured by heating and molding a material such as a net that becomes a wig base to cause the wig base to fit a head shape of a person who uses the wig. Therefore, the hydrophilic material adhered to the fabric may be easily removed due to the hearing and molding process for manufacturing the wig, long-term use of the wig, repeated washing of the wig, and so forth. Thus, the wig is less durable. A conventional wig having a double-net structure tends to deform in its shape due to forces applied from various directions, for example, due to a horizontal movement or twisting, due to being rubbed with something. Restoration of the original shape from the thus deformed wig is difficult.

Therefore, the three-dimensional shaping apparatus 1 according to the present embodiment is used to produce a wig base by using an integrated sheet formed by laminating a soft shape memory polymer on a fabric or on a sheet in form of a net for later using its shape memory function. By using the three-dimensional shaping apparatus 1 according to the present embodiment, adhesion between the fabric or the sheet in form of a net and the shape memory polymer can be significantly increased. That is, the shape memory polymer that is soft can be tightly adhered to the fabric or to the sheet in form of a net to which hair is implanted. In addition, a shaped product can be formed by a shape memory polymer directly on a two-dimensional fabric or on a sheet in form of a net. Accordingly, it is possible to obtain a sheet (an integrated sheet) in which the pattern of the shaped product made of the shape-memory polymer is integrated with the net, in a simple and low-cost manner.

### (Integrated Sheet (Wig Base) Manufacturing Method)

A method for manufacturing a wig base as an example of an integrated sheet will now be described.

### (1) Formation of Shaped Product Using Shape Memory Polymer on Net

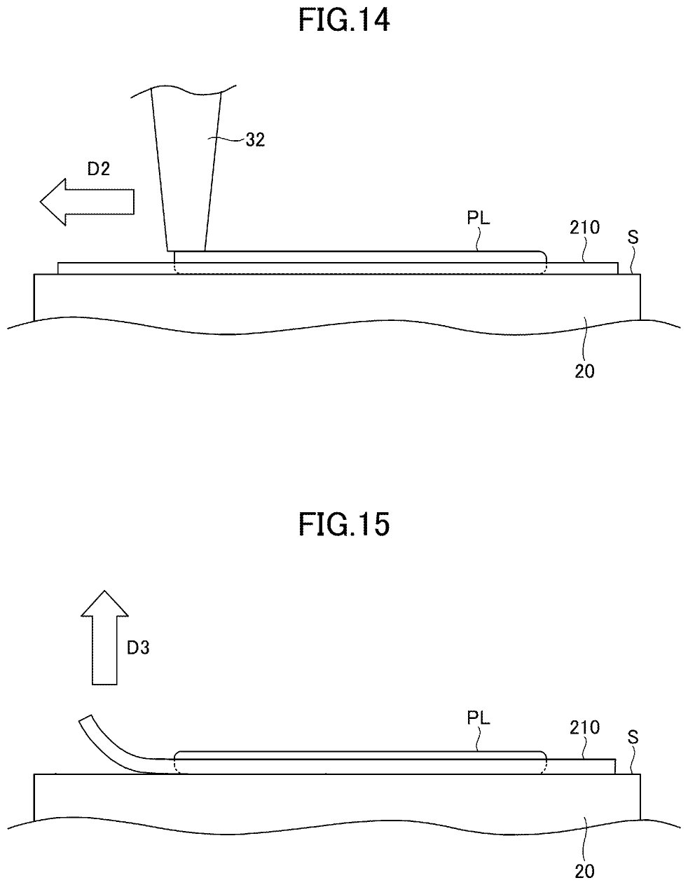

FIG. 14 is a diagram illustrating a method of forming an integrated sheet using the three-dimensional shaping apparatus 1 according to the present embodiment. Specifically, FIG. 14 is a diagram illustrating how to form a shaped product onto a base net 210 placed on the shaping stage 20.

The integrated sheet was produced using the three-dimensional shaping apparatus 1 according to the present embodiment. First, the base net 210 that is a base of the wig base was mounted and fastened to the placement surface S of the shaping stage 20. As the base net 210, a fabric or a sheet in form of a net was used for hair implantation. In the present example, the base net 210 was 0.15 mm thick, had a porosity of 82%, and was made of nylon. The three-dimensional shaping apparatus 1 was set to have a nozzle discharge speed of 6.25 mm³/second and a nozzle maximum speed of 50 mm/second. Then, the shaped product was formed with the gap of 0 mm between the base net 210 and the shaping nozzle 32. These conditions satisfy the conditions of Formula 6 and Formula 8 described above.

The base net 210 was tightly fastened to the shaping stage 20 using a double-sided adhesive tape. The temperature of the shaping stage 20 may be changed as is appropriate. In the present example, the temperature of the shaping stage 20 was not changed. The cylinder heater 31h was such that respective temperatures can be set at four locations; actually, temperatures of 160° C., 180° C., 200° C., and 190° C. were set from the upper side at these four locations. Then, the shaping nozzle 32 was moved as depicted by an arrow D2 to form a required shape, a shaping material was discharged in a molten state from the shaping nozzle 32, and shaping layers PL were layered. As a resin discharged as a shape memory polymer, #2520 (glass transition point 25° C., and melting point 180-190° C.) manufactured by SMP Technologies Inc. was used.

When the three-dimensional shaping apparatus 1 was used to form a shaped product including four layers each having a thickness of 0.25 mm, an elliptical shape with a major-axis length of 15 cm and a minor-axis length of 10 cm, and a honeycomb structure (honeycomb cell size of 5 mm), using the nozzle with the nozzle diameter of 0.5 mm. The time required for forming this shaped product was 18 minutes.

(2) Removal of Wig Base from Stage

FIG. 15 is a diagram illustrating the method of forming the integrated sheet using the three-dimensional shaping apparatus 1 according to the present embodiment. Specifically, FIG. 15 is a diagram illustrating removal of the base net 210 (wig base), on which the shaping layers PL were laminated, from the shaping stage 20.

The base net 210 (wig base) on which the shaping layers PL were laminated was removed from the shaping stage 20. From an end of the base net 210 (wig base) on which the shaping layer PL were laminated, the base net 210 was pulled in the direction of an arrow D3 to remove the base net 210. When removing the wig base, the base net 210 and the shape memory polymer were carefully removed so as not to deteriorate the adhesion between the base net 210 and the shape memory polymer. At this time, the double-sided tape may be removed together for achieving a more careful removal.

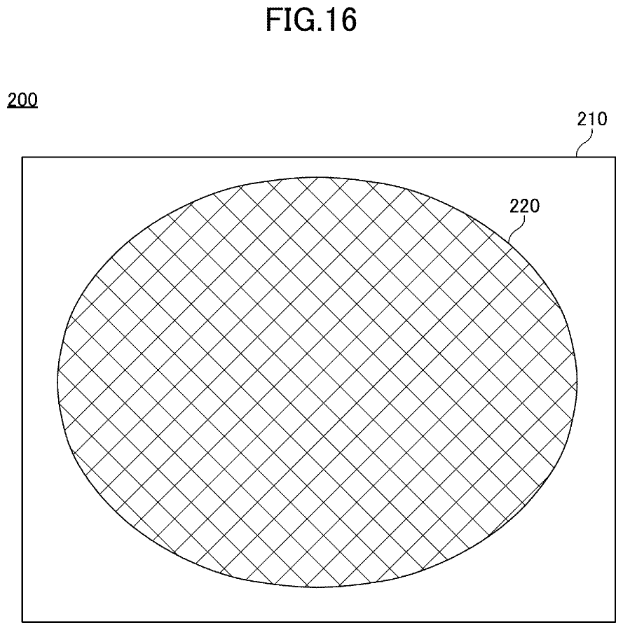

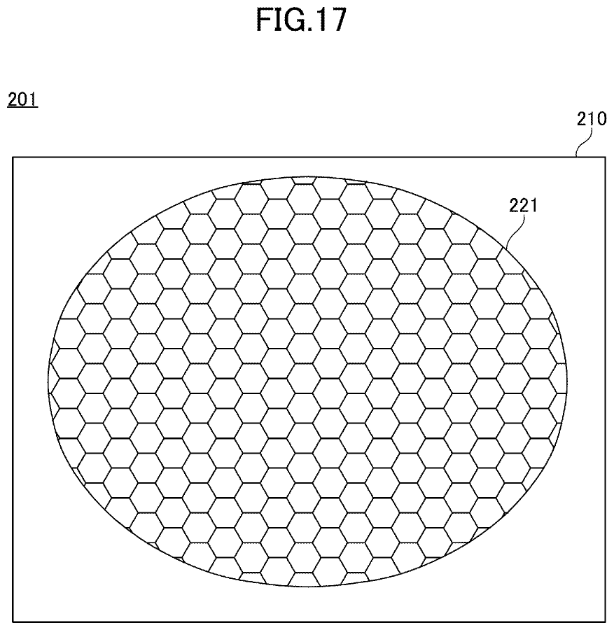

FIGS. 16 and 17 are diagrams illustrating integrated sheets formed by using the three-dimensional shaping apparatus 1 according to the present embodiment. Specifically, FIG. 16 depicts a wig base 200 including shaping layers 220 in which a shape memory polymer is used to form a grid structure (an example of a sheet in form of a net). FIG. 17 depicts a wig base 201 including shaping layers 221 in which a shape memory polymer is used to form a honeycomb structure.

FIGS. 16 and 17 are examples of a shape memory polymer being laminated in an elliptical shape having a major-axis length of 15 cm and a minor-axis length of 10 cm. The base net 210 is implanted with hair for finally forming a wig. In order to implant hair to the base net 210, it is desirable that the density of the meshes of the net be higher than the mesh density of the polymer. The base net 210 used has a grid structure made of nylon and having a mesh size of 1 mm. The mesh sizes of the grid structure and the honeycomb structure of the shape memory polymer are each preferably in the range of about 3 to 10 mm.

### (3) Shape Memory Process for Three-Dimensional Shape

Next, a shape memory process is performed on the base net 210 (wig base) in which the shaping layers PL are laminated so that the base net 210 has therein a memory of a shape of a wig. That is, the shape of the base net 210 (wig base) in which the shaping layers PL are laminated is caused to change according to the shape of the head of the user, and a memory of the shape after the shape change is held in the shaping layers PL made of the shape memory polymer.

FIG. 18 is a diagram illustrating the method of forming the integrated sheet using the three-dimensional shaping apparatus 1 according to the present embodiment. Specifically, FIG. 18 depicts a process of changing the shape of the wig base 200 to fit the shape of a mannequin head 300.

An edge of the wig base 200 is fastened to the mannequin head 300 while the wig base 200 is uniformly pulled in the directions of the arrows D4 so as not to wrinkle or crease the wig base 200. On the mannequin head 300, a human face or the like is drawn, but as long as the shape of the human head can be represented, the human face is not necessarily required. Preferably, the mannequin head 300 is formed (formed by laminating) based on three-dimensional data of the particular person's head shape. The mannequin head 300 is formed, for example, by a three-dimensional printer. The material of the mannequin head 300 is not particularly limited as long as it is easy to shape at low cost. The mannequin head 300 may be made of, for example, a ABS resin, polylactic acid (PLA) resin, or the like. The mannequin head 300 may be formed by cutting using a numerical control (NC) cutting machine. When the mannequin head 300 is formed using a NC cutting machine, the material of the mannequin head 300 is preferably a polyurethane foam, which is easy to cut. Pins, belts, hooks, or the like may be used to fasten the edge of the wig base 200 to the mannequin head 300. However, as long as the wig base 200 that is the integrated sheet can be uniformly stressed and is not damaged, a specific method is not limited to using pins, belts, hooks, or the like. The mannequin head 300 is an example of a head-shaped physical model.

In the present example, the shape of the wig base 200 was changed to fit the shape of the mannequin head 300 by fastening the wig base 200 to the mannequin head 300. Thereafter, the state after the shape change was maintained at a predetermined temperature (e.g., 80° C.) for a predetermined time (e.g., 4 hours) so that the shape after the shape change was able to be held as a memory in the shape memory polymer formed in the wig base 200. The predetermined time and predetermined temperature conditions for this shape memory process are not limited to the above-described conditions. For example, the maintaining time may be shortened and the temperature may be increased.

A three-dimensionally personalized wig base 200 can be thus produced, by fastening the integrated sheet (wig base 200) in a wrinkle-or-crease-free manner to the mannequin head 300 produced using the particular person's three-dimensional data, to allow the integrated sheet to hold therein a memory of a shape in accordance with the desired head shape.

(4) Removal of Wig Base after Shape Memory Process

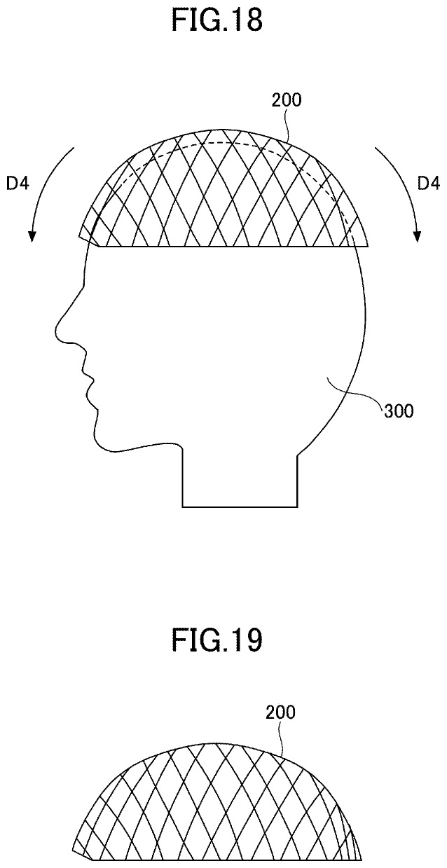

FIG. 19 is a diagram illustrating the method of forming the integrated sheet using the three-dimensional shaping apparatus 1 according to the present embodiment. Specifically, FIG. 19 depicts the wig base 200 removed from the mannequin head 300.

The integrated sheet (wig base 200) holding therein the memory of the shape is a three-dimensional wig base 200 as depicted in FIG. 19. The shape retention force of the wig base 200 has greatly improved compared to the shape retention force of a conventional net that has been shaped in a three-dimensional manner using a molding agent. In addition, it was confirmed that even though the shape of the wig base was deformed due to washing, etc., the shape was returned to a shape, a memory of which was held in the wig base through the shape memory function, by bringing the wig base to have the glass transition point or more with respect to the same memory polymer (in this case, about the human body temperature). In addition, these effects had reproducibility.

### (5) Finish

In order to provide a fastening unit for fastening the wig base to the head of the wig wearer, a fastening base net member is sewn and integrated with the peripheral portion of the wig base 200. The fastening base net member is sewn to the wig base 200 at locations 1 mm inside and 20 mm inside the outer peripheral edge of the wig base 200. Then, the unwanted portion of the fastening base net member is removed. Then, a plurality of fastening pins are disposed on the fastening base net member in accordance with the hair conditions of the wig wearer.

Then, hair (hair material) is implanted on the wig base 200. The wig base is fastened again to the mannequin head 300, and hook needles are inserted into the net of the wig base 200. After the hair (hair material) is hooked to the hook portions of the hook needles, the hair is bound to the hook portions and is implanted. The hair (hair) implanted is natural hair (hair material) or artificial hair (hair material); and is implanted by binding folded lines, obtained from folding the hair at their centers, to the net member via the hook portions.

Although the wig base 200 has been described in the above items (3) to (5), the same manner applies also to the wig base 201. The shape memory process may be performed either before or after the hair implantation.

### (Evaluation)

The integrated sheet thus produced by using the three-dimensional shaping apparatus 1 according to the present embodiment was evaluated by a washing test.

In the washing test, 3 g of shampoo was dissolved in 2 liters of warm water at a temperature of 30° C., then a test piece (the integrated sheet (the produced wig base 200)) was immersed, and the front and back side surfaces of the test piece were hand-washed uniformly for 30 seconds by pushing the test piece up and down in the water, the water being then drained away. The test piece was then rinsed with 2 liters of warm water at a temperature of 30° C. for 30 seconds, and was sandwiched by a towel to remove water. Thereafter, the test piece was dried for 10 minutes with a dryer temperature set at 60° C. with the test piece attached to the mannequin head.

After the washing test described above was repeated 50 times, no peeling off of the shape memory polymer of the wig base 200 occurred and almost no shape deformation occurred.

### Advantageous Effects

By thus producing the integrated sheet (wig base) using the three-dimensional shaping apparatus according to the present embodiment, the integrated sheet (wig base) in which a resin (shape memory polymer) is firmly adhered to a fabric or to a sheet in form of a net was able to be obtained. In addition, by first forming the wig base having the plane structure using the three-dimensional shaping apparatus and then fitting the wig base to a particular person's head shape for causing the wig base to perform a shape memory process, the wig base fitting the particular person's head shape can be thus easily and quickly produced at a low cost. Furthermore, the resin (shape-memory polymer) comes to have a structure of entering the fibers of the fabric or sheet in form of a net, thus is almost integral to the fabric or to the sheet in form of a net, and thus, the wig base can have adhesive properties that can withstand the practical use.

Further, by using the shape memory polymer having a glass transition point less than or equal to the human body temperature in the wig base according to the present example, the shape of the shape memory polymer can be restored and retained at the human body temperature. Thus, the desired head shape can be maintained for a long time. By thus using the shape memory polymer having the glass transition point less than or equal to the human body temperature in the wig base, the shape can be restored and retained at the human body temperature.

In addition, the three-dimensional shaping apparatus according to the present embodiment is capable of discharging a soft material having a longitudinal elastic modulus of 5 MPa or less to form a shaped product. There is a demand for a use of a soft material as a material having body-fitting properties. The three-dimensional shaping apparatus according to the present embodiment includes the extrusion device 30 including the cylinder 31, the screw 34, the cylinder heater 31h provided at the cylinder 31, and the shaping nozzle 32. The extrusion device 30 can discharge a soft material having a longitudinal elastic modulus of 5 MPa or less to form a shaped product to be used as a product having body-fitting properties.

Producing a wig that fits the shape of a human head using, for example, a common three-dimensional printer method, is very time-consuming and costly. For example, using a three-dimensional printer such as a powder sintering type or FDM type (for producing a wig that is three-dimensional using a support material as usual) takes eight hours or more to form a shape similar to the shape described above. In addition, in the case of using these systems, a wig that is rather stiff as a wig is obtained. Moreover, integration with a net is impossible in principle.

[Integrated Sheet with Deodorizing Function]

As the above-described integrated sheet, an integrated sheet that is further provided with a deodorizing function will be described.

A material having body-fitting properties caused uncomfortable “swelling”, and also, caused microbial growth and generated an odor when used in contact with a human body. Sweat and skin waste generated an environment of easily causing microbial growth, thereby causing an odor, dermatitis, or an eczema. Therefore, as the integrated sheet using a material having body-fitting properties, a functional integrated sheet having durability as well as suppressing microbial growth and preventing generation of an unpleasant odor has been required. Therefore, a resin (shape memory polymer) is laminated on a fabric or on a sheet in form of a net to provide adequate moisture permeability.

In the present example, the shape memory polymer of the above-described integrated sheet (wig base) includes a functional material selected from a group of substances having at least either antibacterial activity or deodorizing properties. The substances having at least either antibacterial activity or deodorizing properties include, for example, a zeolite, a transition metal oxide, activated carbon, and the like.

Inorganic antibacterial agents not only prevent direct damage to humans and animals caused by an O157 strain of the E. coli bacteria or another microorganism, but are also highly evaluated as having superior heat resistance and persistent antibacterial activity compared with organic agents. Initially, a focus was solely on providing existing industrial products with new capability of antibacterial activity. However, taking advantage of the characteristics of antibacterial agents, which are particularly excellent in heat resistance and persistent antibacterial activity, has led to an improvement of the living environment, i.e., creation of a sustainable and sterile environment.

Antibacterial agents inhibit growth of microbial groups. In other words, the antibacterial agents fundamentally inhibit production of organic acids, or nitrogen or sulfur-containing compounds, which are formed by metabolism by microorganisms and are easily volatilized and diffused as having small molecular weights. Ability to control growth of microbial groups is a function of a deodorizer.

Antibacterial activity of transition-metal-ion containing zeolites is achieved by inhibiting actions of enzymes in a metabolic system of microorganisms. The transition-metal-ion containing zeolites, for example, silver ions, adsorb to the surfaces of microbes and are taken into bacteria by active transport. The silver ions react with various enzymes of the metabolic system in the microbial bodies, inhibiting the function of various enzymes of the metabolic system and inhibiting growth of microorganisms.

In chemical characteristics of metal ions and odorants, it is known that “hard acids” tend to form stable compounds with “hard bases” and “soft acids” tend to form stable compounds with “soft bases” in accordance with the theory of hard and soft, acids and bases (HSAB). Here, acids refer to not only hydrogen ions but also cationic Lewis acids that include metal ions. The classification between “hard” and “soft” depends on surface charges of ions and spread of electron orbitals. According to HSAB, silver ions are monovalent cations, but are soft acids because of their small surface charges and large ion radiuses; and zinc ions belong to acids intermediate between “hard” and “soft”. Most odorous substances belong to the category of bases. Organic acids are acids, but hydrogen ions readily dissociate to form organic acid anions, and thus, the organic acids have states of bases. Organic acid ions, such as acetic acids and isovaleric acids, also belong to hard bases because of the high surface charges on the oxygen atoms. In addition, ammonia and pyridine belong to bases intermediate between “hard” and “soft”, whereas sulfide and methyl mercaptan belong to soft bases. From these viewpoints of the HSAB theory, the following test results depict a rough proportional relationship between the content of each metal ions and the ability to remove various odor substances. In particular, the results of the test for removal of methyl mercaptan, that is a sulfur-containing compound, depict such a tendency in relation to the silver ion content.

As the transition metals in the present example, elements belonging to groups 3 to 12 in the long-periodic table are preferred, and from the viewpoint of antibacterial or deodorizing properties, silver, zinc, and copper are preferred. The zeolite preferably contains at least one kind of transition metal ions. In the transition-metal-ion containing zeolite, it is preferable to contain from 0.1% to 15% by weight of one or more kinds of transition metal ions in the zeolite.

### (Evaluation 1: Deodorizing Effect Test)

The results of evaluations (deodorizing effect tests) of deodorizing properties of a shape memory polymer containing a group of substances having at least either antibacterial activity or deodorizing properties will now be described.

(Test 1) 2-nonenal

As Test 1, deodorizing effect tests were conducted on 2-nonenal.

An odor of aging is a characteristic of middle-aged and elderly people, and the main cause of the odor of aging is known to be 2-nonenal, an unsaturated aldehyde.

In Test 1, a net was used as a shaped product as an evaluation sample. The net has a thickness of 0.15 mm and a porosity of 82%, the material of the net is nylon, and the net has an elliptical shape having a major-axis length of 15 cm and a minor-axis length of 10 cm. To form a honeycomb structure (having a honeycomb cell size: 5 mm) onto the net that is used as a target, a nozzle with a nozzle diameter of 0.5 mm was used to laminate four layers of resin so that the thickness of one layer was 0.25 mm, and an integrated sheet was produced that integrates the net with the resin.

As the resin, which is a base resin, a pellet of #2520 (having a glass transition temperature of 25° C. and a melting point of 180-190° C.) made by SMP Technologies, Inc. was individually mixed with each of the following being 2% by weight: 1) zeolite, 2) activated carbon, 3) silver oxide, 4) zinc oxide, 5) titanium oxide, 6) Ag-ion containing zeolite, and 7) Zn-ion containing zeolite, belonging to a group of substances having at least either antibacterial activity or deodorizing properties. That is, integrated sheets (hereinafter, referred to as embodiment samples) were prepared using a total of seven types of resins. The above-described mixture is a powder having an average grain diameter of about 1 to 5 μm. As the zeolite, a zeolite having a specific surface area of 600 m²/g was used. As a comparative example, an integrated sheet (hereinafter referred to as a comparative sample) was prepared only including the base resin.

Each of the seven samples of the embodiment samples and the comparative sample was placed in an odor bag, which was heat-sealed, and then, was sealed with 4 L of air. Then, 2-nonenal was added to result in a set concentration (initial gas concentration: 20 ppm). The sample with the added 2-nonenal was left statically at room temperature, and 300 ml of gas in the bag was taken in a DNPH (2,4-dinitrophenylhydrazine) cartridge at each elapsed time (after 0, 30, 60, and 180 minutes). A DNPH derivative was eluted by causing 5 ml of acetonitrile to pass through the gas-trapped DNPH cartridge. The eluted liquid was measured by a high performance liquid chromatography to calculate the concentration of 2-nonenal in the bag.

The specific reagents and the like were as follows.

Odor bag (25 cm×40 cm): ARAM corporation

Nonenal gas: gas generated from trans-2-nonenal (1st Grade, Wako Pure Chemical corporation)

DNPH cartridge: GL-Pak mini AERO DNPH (GL Sciences Inc.)

High performance liquid chromatography
model: LC-2010AHT (Shimadzu Corporation)
column: RP-Amide, φ4.6 mm×25 cm
column temperature: 40° C.
mobile phase: mixture of acetonitrile and water (acetonitrile:water=4:1)
mobile phase flow rate: 1.5 ml/min
measurement wavelength: 360 nm
injected amount: 40 μl

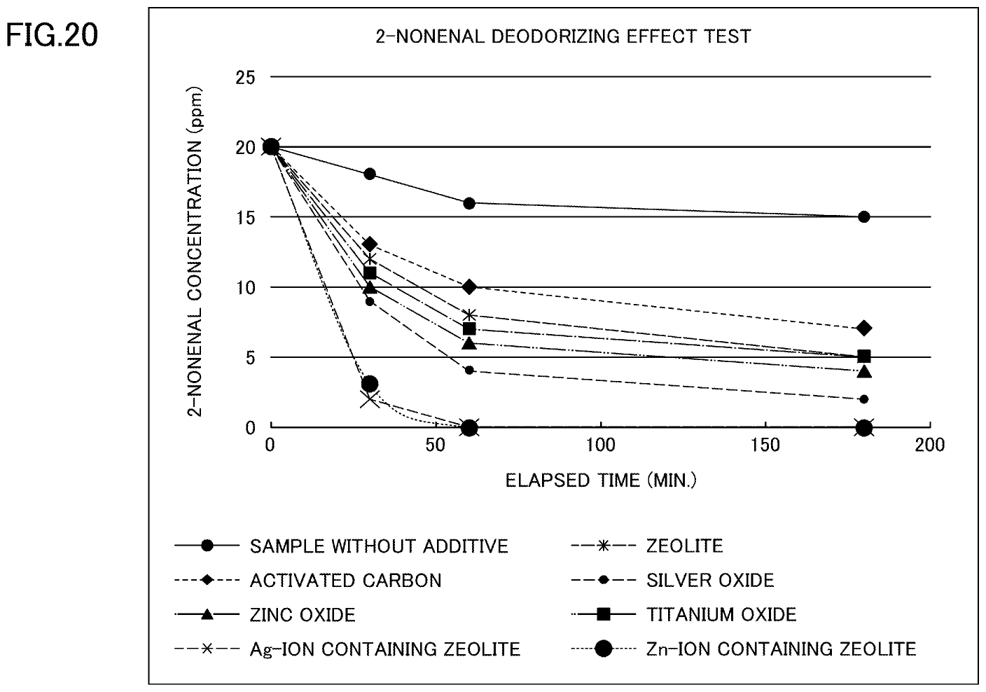

FIG. 20 is a diagram illustrating the results of the deodorizing effect tests (Test 1) of the integrated sheets formed using the three-dimensional shaping apparatus according to the present embodiment.

From FIG. 20, it can be seen that the deodorizing effects were achieved against 2-nonenal as a result of each of the resins being made to individually contain a different one of the following being 2% by weight: 1) zeolite, 2) activated carbon, 3) silver oxide, 4) zinc oxide, 5) titanium oxide, 6) Ag-ion containing zeolite, and 7) Zn-ion containing zeolite, which belong to the group of substances having at least either antibacterial activity or deodorizing properties.

### (Test 2) Diacetyl

Deodorizing effect tests were performed on diacetyl as Test 2.

Diacetyl is a causative agent of unpleasant greasy odor of middle men in their 30s to 40s. Skin-endemic bacteria such as Staphylococcus epidermidis have been implicated in metabolizing lactic acids in sweat to generate diacetyl.

The test method was the same as the test method of Test 1.

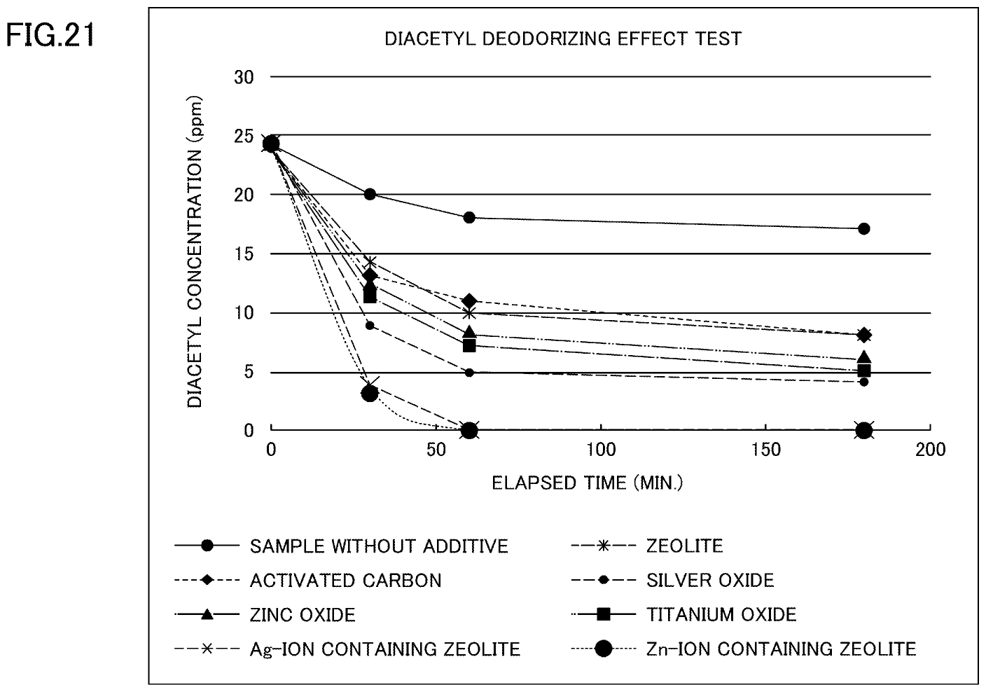

FIG. 21 is a diagram illustrating the results of the deodorizing effect tests (Test 2) of the integrated sheets formed by using the three-dimensional shaping apparatus according to the present embodiment.

From FIG. 21, it can be seen that the deodorizing effects were achieved against diacetyl as a result of each of the resins being made to individually contain a different one of the following being 2% by weight: 1) zeolite, 2) activated carbon, 3) silver oxide, 4) zinc oxide, 5) titanium oxide, 6) Ag-ion containing zeolite, and 7) Zn-ion containing zeolite, belonging to the group of substances having at least either antibacterial activity or deodorizing properties.

### (Test 3) Hydrogen Sulfide

Deodorizing effect tests were performed on hydrogen sulfide as Test 3.

Hydrogen sulfide is responsible for odor of a rotten egg. Hydrogen sulfide is generated when sulfur is reduced by anaerobic bacteria.

The test method was the same as the test method of Test 1.

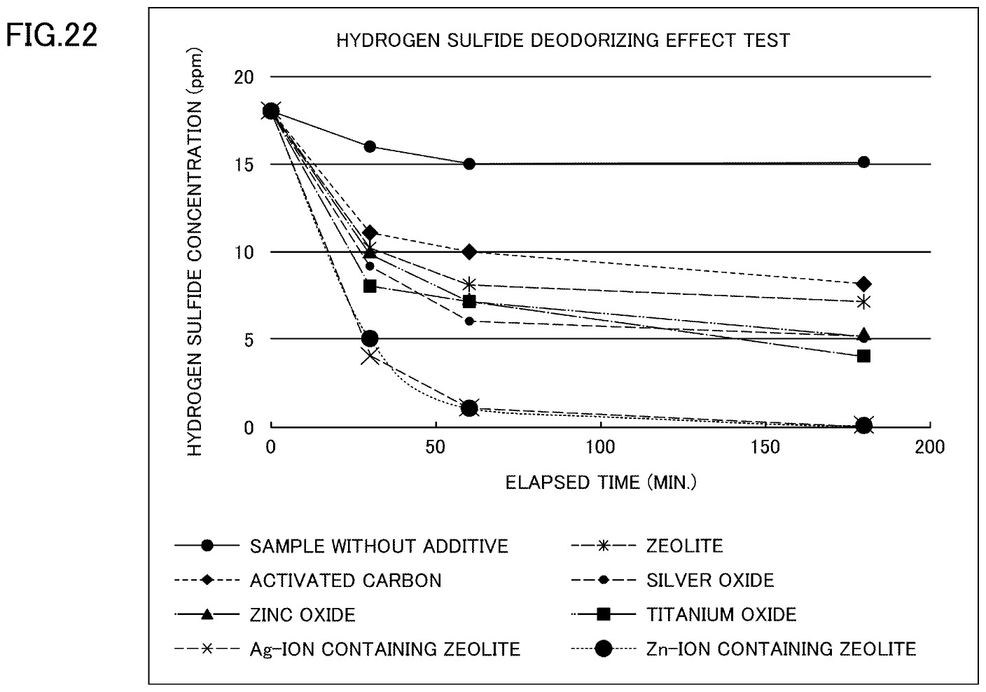

FIG. 22 is a diagram illustrating the results of the deodorizing effect tests (Test 3) of the integrated sheets formed using the three-dimensional shaping apparatus according to the present embodiment.

From FIG. 22, it can be seen that the deodorizing effects were achieved against hydrogen sulfide as a result of each of the resins being made to individually contain a different one of the following being 2% by weight: 1) zeolite, 2) activated carbon, 3) silver oxide, 4) zinc oxide, 5) titanium oxide, 6) Ag-ion containing zeolite, and 7) Zn-ion containing zeolite, belonging to the group of substances having at least either antibacterial activity or deodorizing properties.

### (Test 4) Ammonia

Deodorizing effect tests on ammonia were performed as Test 4.

Ammonia is a gas with a pungent odor. Ammonia is generated during a process of degrading proteins by the liver in a human body. As liver function deteriorates, sweat and urine come to have an ammoniacal odor.

The test method was the same as the test method of Test 1.

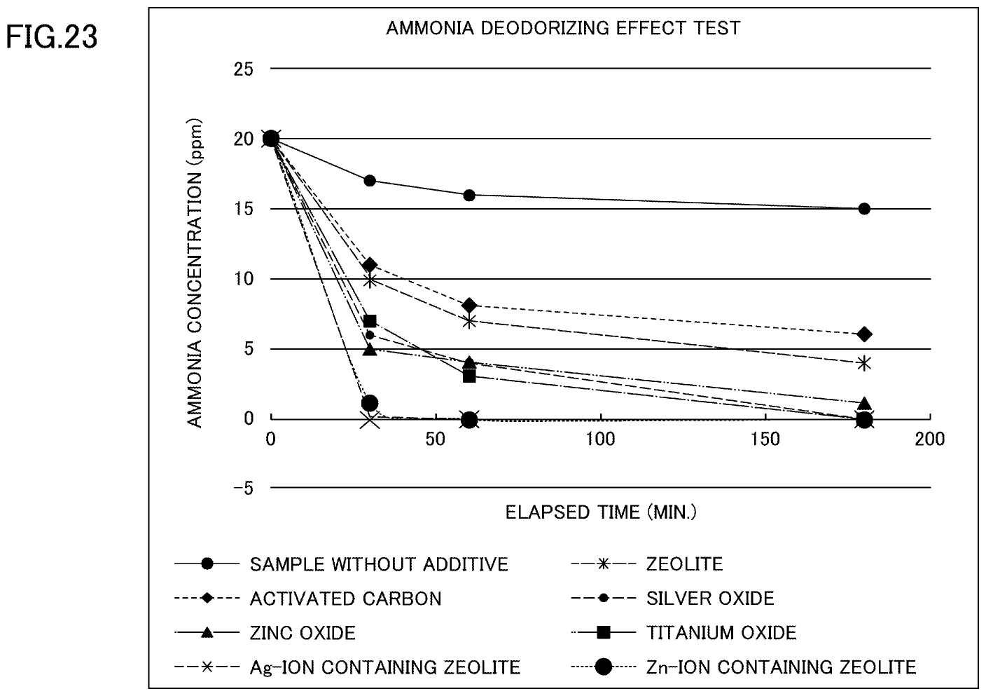

FIG. 23 is a diagram illustrating the results of the deodorizing effect tests (Test 4) of the integrated sheets formed using the three-dimensional shaping apparatus according to the present embodiment.

From FIG. 23, it can be seen that the deodorizing effects were achieved against ammonia as a result of each of the resins being made to individually contain a different one of the following being 2% by weight: 1) zeolite, 2) activated carbon, 3) silver oxide, 4) zinc oxide, 5) titanium oxide, 6) Ag-ion containing zeolite, and 7) Zn-ion containing zeolite, belonging to the group of substances having at least either antibacterial activity or deodorizing properties.

As described above, by using the resins containing the group of substances having at least either antibacterial activity or deodorizing properties, the deodorizing effects were achieved, and particularly, by causing the resins to contain zeolite that contains transition metal ions, the great effects were achieved.

### (Evaluation 2: Washing Resistance Test)

Washing resistance of the resins that contain the group of substances having at least either antibacterial activity or deodorizing properties of the present example were evaluated. As an integrated sheet of the present example, an integrated sheet in which Ag-ion containing zeolite was mixed and the mixture was kneaded was used.

Conventionally, it is known to use a dispersion liquid that contains a binder resin for attaching (or impregnating) a functional material having antibacterial activity or deodorant properties (or impregnated) to fibers. For example, it is disclosed that a solution of a zeolite powder that contains silver ions dispersed in an acrylic binder is used to obtain a functional material by impregnating and coating the material to the fibers (for example, see Japanese Patent Application Publication No. H08-246334, Japanese Patent Application Publication No. H10-292268, Japanese Patent Application Publication No. 2017-193793, etc.).

Therefore, as a comparative example, a binder was used to implement impregnating. An integrated sheet made by integrating a shape memory polymer that does not contain antibacterial and deodorizing materials in a net was processed using a binder to impregnate Ag ion containing zeolite at an amount of 2 g/m². As the acrylic binder resin, an acrylic binder “SZ-70” provided by Sinanen Zeomic Co., Ltd. was used to disperse 35% by weight of Ag-ion containing zeolite.

The washing test was performed as follows: First, 3 g of shampoo was dissolved in 2 liters of warm water at a temperature of 30° C. and the test piece was immersed. Then, the front side surface and the back side surface of the test piece were washed equally for 30 seconds by pushing the test piece up and down in the water, and the water was drained away. Then, the test piece was rinsed with 2 liters of warm water at 30° C. for 30 seconds, and the water was removed by sandwiching the test pierce with a towel. Then, a dryer was used to dry the test piece for 10 minutes at a temperature of 60° C. In the present experiment, the deodorizing effect achieved during 30 minutes before washing was assumed as 100%, and washing was repeated several times to check how much deodorizing effect remains during 30 minutes each time after the washing.

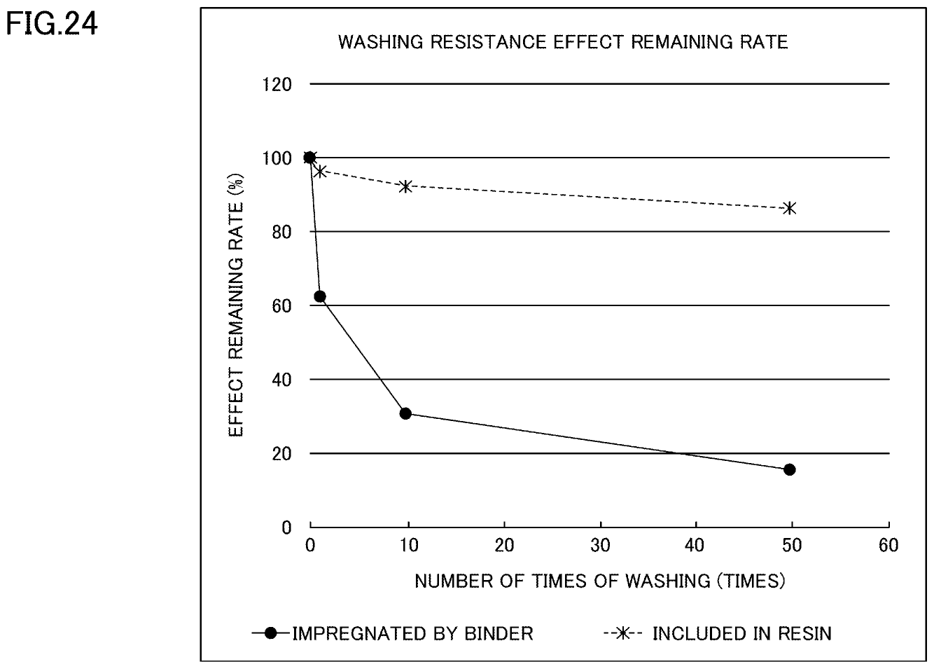

FIG. 24 is a diagram illustrating the result of the washing resistance test of the integrated sheet formed using the three-dimensional shaping apparatus according to the present embodiment.

In the washing test, with respect to the integrated sheet where Ag-ion-containing zeolite was mixed and the mixture was kneaded in the present example (indicated by the broken line), deterioration of the deodorizing effect was almost not observed. On the other hand, with respect to the comparative example where the binder was used to implement impregnating (indicated by the solid line), the deodorizing effect sharply deteriorated.

### (Evaluation 3: Antibacterial Activity Test)

The antibacterial activity of an integrated sheet formed using the three-dimensional shaping apparatus according to the present embodiment will now be discussed.

Most of odorous substances released from a human body are produced as a result of biological metabolism and are compounds that are part of proteins in the body before being metabolized. By the antibacterial mechanism of the present disclosure, silver ions and zinc ions are incorporated into bacteria and bind to sulfur-and-nitrogen-containing proteins, thereby inhibiting the electron transfer system activity and destructing protein's higher-order structure. In consideration of these facts, the deodorizing action is inextricably linked with the antibacterial action. That is, the antibacterial ability of the present disclosure is an “active” action in which silver ions or zinc ions are eluted and taken by bacterium, whereas the deodorizing ability can be seen as a “passive” action in which an integrated sheet according to the embodiment and variant of the present invention performs the function on an odorous substance which has entered the integrated sheet.

The ability of Lewis acids, such as silver and zinc ions, to kill bacteria and deodorize odors, is exerted depending on the ability to form chemical bonds with various Lewis bases.

The antibacterial activity was evaluated as will now be described. The antibacterial activity was evaluated according to Japanese Industrial Standards (JIS) L 1902 “Testing Antibacterial Activity and Efficacy on Textile Products”.

The antibacterial activity test was conducted under the conditions of 1/20 NB of the bacterial suspension concentration, 0.2 ml of the bacterial droplet volume, 37±1° C. of the storage temperature, and 18±1 hours of the storage time. The presence or absence of antibacterial activity was evaluated by a value of bactericidal activity calculated by the formula shown below. If the value of bactericidal activity was 0 or higher, it was considered that the integrated sheet had antibacterial activity.

A: the number of bacteria collected after dispersing bacteria immediately after inoculation in an unprocessed fabric

B: the number of bacteria collected after dispersing bacteria after 18 hours of cultivation in a processed fabric

bactericidal activity value=log A/B

The result of the antibacterial activity test is depicted in Table 5. When zeolite and activated carbon were used, little antibacterial activity was observed, whereas, when transition metal oxides were used, antibacterial activity was observed. When zeolites that contain transition metal ions were used, high antibacterial activity was observed.

TABLE 5

| | sample | | | | | | Ag—ion | Zn—ion |
|---|---|---|---|---|---|---|---|---|
| | without | | activated | silver | zinc | titanium | containing | containing |
| | additive | zeolite | carbon | oxide | oxide | oxide | zeolite | zeolite |
| bactericidal | −1.48 | −0.84 | −1.22 | 2.48 | 2.33 | 2.3 | 3.45 | 3.22 |
| activity | | | | | | | | |
| value | | | | | | | | |

### Advantageous Effects

According to the present embodiment, a shape memory polymer having body-fitting properties is used in an integrated sheet where the resin is integrated with a fabric or with a sheet in form of a net, and thus, the integrated sheet is designed to fit to human body. The shape memory polymer adheres closely to the fabric or the net and does not peel off easily, and thus, the integrated sheet has reliability. Further, according to the present embodiment, the integrated sheet can be easily and quickly shaped at a low cost. In addition to thus using the material having body-fitting properties, according to the present embodiment, it is possible to provide a functional combination product that suppresses microbial growth, prevents generation of offensive odors, has adequate moisture permeability, and is durable to human body movement.

The fabric or the sheet in form of a net is an example of a base material. The shape memory polymer is an example of a chief material of the resin.

The shaping apparatuses, shaping methods, combination products, combination product manufacturing methods, wig bases, wigs, and wig manufacturing methods have been described with reference to the embodiments. However, the present invention is not limited to these embodiments, and various modifications or variations can be made within the scope of the present invention. For example, it is possible to modify each embodiment without departing from the spirit of the present invention. For example, it is possible to combine the structures described with respect to the embodiments and other elements.

### RELATED ART DOCUMENTS

### Patent Documents

[Patent Document 1] Japanese Patent Application Publication No. 2018-167405

What is claimed is:

1. A shaping apparatus configured to use a shaping material to form a shaped product on a target placed on a shaping stage, the shaping apparatus comprising:
a discharger configured to discharge the shaping material onto the target; and
a processor configured to control a distance between the target and the discharger based on a characteristic value of the target.

2. The shaping apparatus according to claim 1,
wherein
the characteristic value includes at least a thickness and a porosity of the target.

3. The shaping apparatus according to claim 2,
wherein
the distance g (mm) between the target and the discharger satisfies conditions defined by Formula 1,
$$- t \frac{PS}{100} \leq ℊ \leq \frac{100 - PS}{100} \times \frac{FR}{vd} \qquad [ Formula 1 ]$$
wherein
t (mm) denotes the thickness, PS (%) denotes the porosity, FR (mm³/s) denotes a flow rate of the discharger, v (mm/s) denotes a linear velocity of the discharger, and d (mm) denotes an extending-end diameter of the discharger.

4. The shaping apparatus according claim 1,
wherein
the target is a fabric or is a sheet in form of a net.

5. The shaping apparatus according to claim 1,
wherein
the discharger includes a cylinder configured to supply the shaping material, a screw, and a heater provided at the cylinder, and
wherein
the shaping material supplied inside the cylinder is heated and molten.

6. A shaping method for using a shaping material to implement shaping on a target placed on a shaping stage, the shaping method comprising
controlling, by a processor, a distance between the target and a discharger, configured to discharge the shaping material onto the target, in such a manner to make the distance become a distance based on a characteristic value of the target, and discharging the shaping material from the discharger.

7. The shaping method according to claim 6,
wherein
the shaping material comprises any one from among 1) a resin having a longitudinal elastic modulus of 5 MPa or less, 2) a resin having a glass transition temperature of 40° C. or less, and 3) a shape memory polymer.

8. A combination product in which a base material and a resin shaped to have a desired shape are integrated,
wherein
the resin comprises any one of 1) a resin having a longitudinal elastic modulus of 5 MPa or less, 2) a resin having a glass transition temperature of 40° C. or less, or 3) a shape memory polymer.

9. The combination product according to claim 8,
wherein
the desired shape is a net shape.

10. The combination product according to claim 8, further comprising
a functional material.

11. The combination product according to claim 10,
wherein
the functional material is a material having an antibacterial activity or deodorizing properties.

12. The combination product according to claim 10,
wherein
the functional material is at least one material selected from among three materials that are zeolite, a transition metal oxide, and activated carbon.

13. The combination product according to claim 8, having a sheet shape in which the base material and the resin are integrated.

14. The combination product according to claim 8,
wherein
the base material is a fabric or a sheet in form of a net.

15. A method for manufacturing the combination product according to claim 8, wherein the method comprising:
controlling a distance between the base material and a discharger, configured to discharge the resin to the base material, in such a manner to make the distance become a distance based on a characteristic value of the base material, and discharging the resin from the discharger.

16. The method for manufacturing the combination product according to claim 15, comprising
discharging the resin to the base material in such a manner that the resin comes to have a desired shape.

17. A wig base comprising
the combination product according to claim 8.

18. A wig comprising:
the wig base according to claim 17; and
hair material.

19. A wig manufacturing method, the method comprising
changing a shape of the wig base that is according to claim 17 in such a manner that the wig base comes to have a shape in accordance with a desired head shape.

20. A wig manufacturing method, the method comprising:
forming a head-shaped physical model shaped by laminating; and
changing a shape of the wig base that is according to claim 17 in such a manner that the wig base comes to have a shape in accordance with the head-shaped physical model.
